(19) United States
(12) Patent Application Publication
(10) Pub. No.: US 2016/0112316 A1
(43) Pub. Date: Apr. 21, 2016

(54) DECISION FACTORY AND ITS APPLICATION IN FRR

(71) Applicant: Telefonaktiebolaget L M Ericsson (publ), Stockholm (SE)

(72) Inventors: Anjing Wang, San Jose, CA (US); Kiran Sasidharan Pillai, San Jose, CA (US); Allwyn Carvalho, Alameda, CA (US); Sunny Wang, Saratoga, CA (US)

(21) Appl. No.: 14/515,964

(22) Filed: Oct. 16, 2014

(51) Int. Cl. H04L 12/741; H04L 12/721; H04L 29/06

(52) U.S. Cl. CPC H04L 45/745; H04L 69/22; H04L 45/566

(57) ABSTRACT

Exemplary methods include generating a plurality of prefix entries, wherein each prefix entry includes information for associating incoming traffic to a data structure. In one embodiment, the methods further include generating a plurality of data structures, wherein one or more of the plurality of data structures includes a reference to a master entry. In one embodiment, the methods further include generating the master entry, wherein the master entry includes information for determining how to use the data structures to forward incoming traffic to one or more of the plurality of other network devices.

### FIELD

Embodiments of the invention relate to the field of packet networks; and more specifically, to the fast convergence of next hop entries.

### BACKGROUND

In a conventional router or switch device, next hop (NH) entries typically form fixed chains, and packets are processed by the device as they traverse these chains. A NH entry can either be a non-connected NH entry or a connected NH entry. As used herein, a non-connected NH (non-CNH) entry is a data structure that contains information chaining (i.e., linking) it to another NH entry, and a connected NH (CNH) entry is a data structure that contains information which enables the packets to be forwarded to a connected physical device (i.e., a device that is the immediate next hop in the network).

FIG. 1 illustrates conventional Fast Re-Route (FRR) device 100 comprising of conventional FRR NH entries 101-102. FRR NH entries are commonly referred as “double barrel” next hop entries because each FRR NH entry references two other next hop entries: a primary next-hop entry and a backup next-hop entry, which is used when the primary chain fails. As used herein, one NH entry “referencing” another NH entry refers to a NH entry containing an identifier/pointer that maps/points (i.e., references) another NH entry. In FIG. 1, FRR NH entry 101 includes Forwarding Information Base (FIB) NH entry 111 that references non-CNH 112, which in turn references CNH 113. NH entries 111-113 make up the primary chain. FRR NH entry 101 also includes FIB NH entry 115 that references non-CNH 116, which in turn references CNH 117. NH entries 115-117 make up the backup chain, which is used when the primary chain fails. FRR NH entry 102 includes FIB NH entry 121 that references non-CNH 122, which in turn references CNH 123. NH entries 121-123 make up the primary chain. FRR NH entry 102 also includes FIB NH entry 125 that references non-CNH 126, which in turn references CNH 127. NH entries 125-127 make up the backup chain, which is used when the primary chain fails. It should be noted here that there can be zero or more non-CNH entries in any given chain. For example, FIB NH entry 111 can reference CNH entry 113 directly, without having to reference non-CHN entry 112. By way of further example, non-CNH entry 112 can reference another non-CNH entry instead of referencing CNH entry 113.

When switching from the primary chain to the backup chain, or vice versa, the device needs to be programmed with the correct next-hop entry that is to be used. This is not a problem when the number of FRR-NH entries is small. However, when a single event causes the switching of hundreds of thousands of FRR NH entries, it can take many seconds to reprogram the device with the new next-hop information. Thus, there is a need for a mechanism that enables the FRR NH entries to be reprogrammed quickly when a failure event is detected.

### SUMMARY

Exemplary methods performed by a first network device that is communicatively coupled to a plurality of other network devices in a network include generating a plurality of prefix entries, wherein each prefix entry includes information for associating incoming traffic to a data structure, generating a plurality of data structures, wherein one or more of the plurality of data structures includes a reference to a master entry, and generating the master entry, wherein the master entry includes information for determining how to use the data structures to forward incoming traffic to one or more of the plurality of other network devices.

According to one embodiment, generating the plurality of data structures comprises generating a first next hop entry that includes a master entry identifier (ME ID) that references the master entry, and generating a second next hop entry referenced by the master entry, and wherein generating the master entry comprises generating the master entry that includes a next hop identifier (NH ID) and information identifying a switch event, wherein a non-occurrence of the switch event causes a first chain of one or more next hop entries to be used, the first chain comprising of at least the first next hop entry, and wherein an occurrence of the switch event causes a second chain of next hops to be used, the second chain of next hops comprising of the first next hop entry and the second next hop entry referenced by the NH ID.

In one embodiment, the plurality of other network devices includes a second network device, wherein the first network device is configured to serve as an active inter-chassis redundancy (ICR) device of an ICR system, and the second network device is configured to serve as a standby ICR device of the ICR system. In one such embodiment, the second next hop entry includes information that causes incoming traffic of the first network device to be forwarded to the second network device. In one such embodiment, the methods further include in response to detecting an occurrence of the switch event, sending an indication to the second network device, the indication causing the second network device to become the active ICR device of the ICR system and further causes the second network device to not direct its incoming traffic to the first network device, and in response to receiving an indication from the second network device indicating it is ready to forward incoming traffic to a network device other than the first network device, causing the second chain of next hops to be used thereby allowing incoming traffic of the first network device to be forwarded to the second network device.

According to one embodiment, generating the plurality of data structures comprises generating a Fast Re-Route next hop (FRR NH) entry that references a first chain of next hop entries and a second chain of next hop entries, and wherein the FRR NH entry includes a master entry identifier (ME ID) referencing the master entry, and wherein generating the master entry comprises generating the master entry that includes information identifying a switch event, wherein a non-occurrence of the switch event causes the first chain of next hop entries to be used for forwarding incoming traffic, and wherein an occurrence of the switch event causes the second chain of next hop entries to be used for forwarding incoming traffic.

In one embodiment, the plurality of other network devices includes a second network device, wherein the first network device is configured to serve as an active inter-chassis redundancy (ICR) device of an ICR system, and the second network device is configured to serve as a standby ICR device of the ICR system. In one such embodiment, the second chain of next hop entries includes information that causes incoming traffic of the first network device to be forwarded to the second network device. In one such embodiment, the methods further include in response to detecting an occurrence of the switch event, sending an indication to the second network device, the indication causing the second network device to become the active ICR device of the ICR system, and further causes the second network device to not direct its incoming traffic to the first network device, and in response to receiving an indication from the second network device indicating it is ready to forward incoming traffic to a network device other than the first network device, causing the second chain of next hop entries to be used for forwarding incoming traffic, thereby allowing incoming traffic of the first network device to be forwarded to the second network device.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating the chaining of FRR NH entries in a conventional FRR device.

FIG. 2 is a block diagram illustrating the chaining of FRR NH entries using a decision factory according to one embodiment.

FIG. 3 is a block diagram illustrating the chaining of FRR NH entries using a decision factory in the case where NH entries are shared according to one embodiment.

FIG. 4 is a block diagram illustrating a network device that implements the chaining of NH entries using a decision factory according to one embodiment.

FIG. 5 is a flow diagram illustrating a method for chaining NH entries using a decision factory according to one embodiment.

FIG. 6A is a block diagram illustrating a block diagram illustrating network devices using decision factories in an Inter Chassis Redundancy (ICR) mode, according to one embodiment.

FIG. 6B is a block diagram illustrating a block diagram illustrating network devices using decision factories in an Inter Chassis Redundancy (ICR) mode, according to one embodiment.

FIG. 6C is a block diagram illustrating a block diagram illustrating network devices using decision factories in an Inter Chassis Redundancy (ICR) mode, according to one embodiment.

FIG. 6D is a block diagram illustrating a block diagram illustrating network devices using decision factories in an Inter Chassis Redundancy (ICR) mode, according to one embodiment.

FIG. 7 is a flow diagram illustrating a method for using decision factories in an ICR system.

FIG. 8 is a block diagram illustrating a network device that implements the chaining of NH entries using a decision factory according to one embodiment.

FIG. 9 is a flow diagram illustrating a method for chaining NH entries using a decision factory according to one embodiment.

FIG. 10A is a block diagram illustrating a block diagram illustrating network devices using decision factories in an Inter Chassis Redundancy (ICR) mode, according to one embodiment.

FIG. 10B is a block diagram illustrating a block diagram illustrating network devices using decision factories in an Inter Chassis Redundancy (ICR) mode, according to one embodiment.

FIG. 10C is a block diagram illustrating a block diagram illustrating network devices using decision factories in an Inter Chassis Redundancy (ICR) mode, according to one embodiment.

FIG. 10D is a block diagram illustrating a block diagram illustrating network devices using decision factories in an Inter Chassis Redundancy (ICR) mode, according to one embodiment.

FIG. 11 is a flow diagram illustrating a method for using decision factories in an ICR system.

FIG. 12A illustrates connectivity between network devices (NDs) within an exemplary network, as well as three exemplary implementations of the NDs, according to some embodiments of the invention.

FIG. 12B illustrates an exemplary way to implement the special-purpose network device 1202 according to some embodiments of the invention.

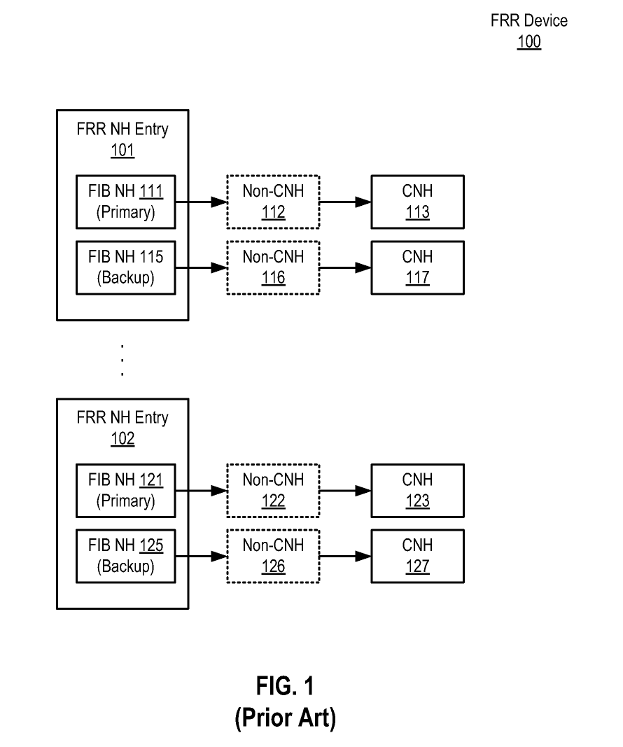

### DESCRIPTION OF EMBODIMENTS

The following description describes methods and apparatuses for performing quick convergence of next hop entries. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

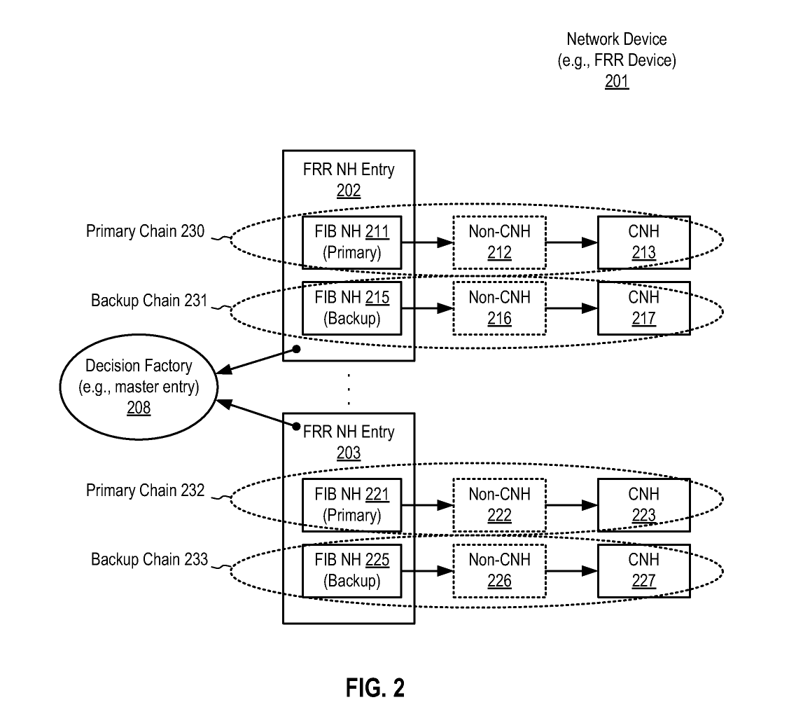

FIG. 2 is a block diagram illustrating network device (e.g., FRR device) 201 according to one embodiment. In FIG. 2, FRR device 201 is shown as having two FRR NH entries (i.e., FRR NH entries 202-203). It shall be appreciated, however, that FRR device 201 can include more or less FRR NH entries without departing from the broader scope and spirit of the present invention. FRR NH entry 202 includes FIB NH entry 211 that references non-CNH 212, which in turn references CNH 213. NH entries 211-213 make up primary chain 230. FRR NH entry 202 also includes FIB NH entry 215 that references non-CNH 216, which in turn references CNH 217. NH entries 215-217 make up backup chain 231, which is used when primary chain 230 fails. FRR NH entry 203 includes FIB NH entry 221 that references non-CNH 222, which in turn references CNH 223. NH entries 221-223 make up primary chain 232. FRR NH entry 203 also includes FIB NH entry 225 that references non-CNH 226, which in turn references CNH 227. NH entries 225-227 make up backup chain 233, which is used when the primary chain fails.

Throughout the description, references are made to NH entries. It shall be understood that these NH entries are data structures used for forwarding/routing traffic. These NH entries can be implemented as part of a control plane, a forwarding abstraction layer, or the forwarding plane. A NH entry can either be a non-connected NH entry or a connected NH entry. As used herein, a non-connected NH (non-CNH) entry is a data structure that contains information chaining (i.e., linking) it to another NH entry, and a connected NH (CNH) entry is a data structure that contains information which enables the packets to be forwarded to a connected physical device (i.e., a device that is the immediate next hop in the network).

As described above, when switching from the primary chain to the backup chain, or vice versa, the device needs to be programmed with the correct NH entry that is to be used. This is not a problem when the number of FRR-NH entries is small. However, when a single event causes the switching of hundreds of thousands of FRR NH entries, it can take many seconds to reprogram the device with the new next-hop information. Embodiments of the present invention overcome these limitations by including decision factory 208 as part of FRR device 201. Throughout the description, a decision factory shall interchangeably be referred to as a “master entry”.

In one embodiment, master entry 208 is referenced by one or more FRR NH entries. In this example, two FRR NH entries (i.e., FRR NH entries 202-203) reference master entry 208. It shall be understood, however, that more or less FRR NH entries can reference master entry 208. Further, although only one master entry is shown, one having ordinary skill in the art would recognize that more master entries can be included as part of FRR device 201. For example, FRR NH entries 202 and 203 can each reference a different master entry.

In one embodiment, master entry 208 includes information that enables FRR device 201 to determine whether a FRR NH entry should forward traffic using its primary chain or its backup chain, based on one or more predetermined conditions. For example, master entry 208 can include a predetermined event (e.g., a link failure), wherein the occurrence or non-occurrence of the predetermined event determines whether a primary chain or the backup chain should be used for forwarding traffic. Thus, master entry 208 enables FRR device 201 to automatically and simultaneously switch from multiple primary chains to multiple backup chains, or vice versa, with the occurrence of a single event. Contrary to a conventional FRR device, FRR device 201, with the benefits of master entry 208, does not need to be re-programmed one FRR NH entry at a time, thereby reducing the re-convergence time when the event occurs. Various aspects of master entries 208 shall become apparent through the discussion of various other figures below.

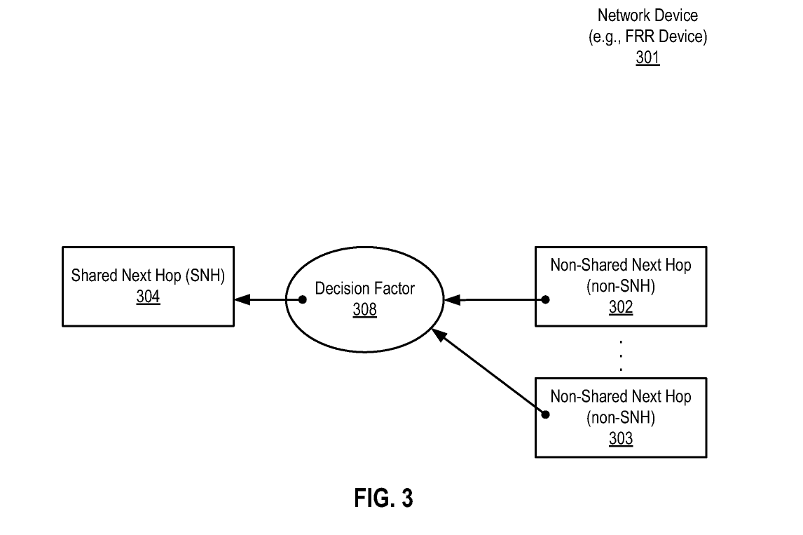

FIG. 3 is a block diagram illustrating network device (e.g., FRR device) 301 according to one embodiment. When multiple primary (or backup) chains refer to the same set of one or more NH entries, the same set of NH entries can be shared by the multiple FRR NH entries whose primary (or backup) chains refer to the shared NH entry, and the backup (or primary) chains can refer to non-shared NH entries. By way of example, referring now back to FIG. 2, assume that NH entries 211-213 are the same as NH entries 221-223. In such an example, NH entries 211-213 and NH entries 221-223 can be implemented as shared NH (SNH) entry 304. NH entries 215-217 (of FIG. 2) can be implemented as non-shared NH (non-SNH) entry 302 (of FIG. 3), and NH entries 225-227 (of FIG. 2) can be implemented as non-SNH entry 303 (of FIG. 3). It shall be understood that the shared and/or non-shared NH entries shown in FIG. 3 can represent one or more NH entries.

In one embodiment, master entry 308 is referenced by one or more non-SHN entries. In this example, non-SNH entries 302-303 reference master entry 308. It shall be understood, however, that more or less non-SNH entries can reference master entry 308. Further, although only one master entry is shown, one having ordinary skill in the art would recognize that more master entries can be included as part of FRR device 301. For example, non-SNH entries 302-303 can each reference a different master entry.

In one embodiment, master entry 308 includes information that enables FRR device 301 to determine whether traffic should be forwarded using the shared or non-shared NH entries, based on one or more predetermined conditions. For example, master entry 308 can include a predetermined event (e.g., a link failure), wherein the occurrence or non-occurrence of the predetermined event determines whether traffic is forwarded using the shared or non-shared NH entries. Thus, master entry 308 enables FRR device 301 to automatically and simultaneously switch from shared NH entries and non-shared NH entries with the occurrence of a single event. Contrary to a conventional FRR device, FRR device 301, with the benefits of master entry 308, does not need to be re-programmed one NH entry at a time, thereby reducing the re-convergence time when the event occurs. Various aspects of master entries 308 shall become apparent through the discussion of various other figures below.

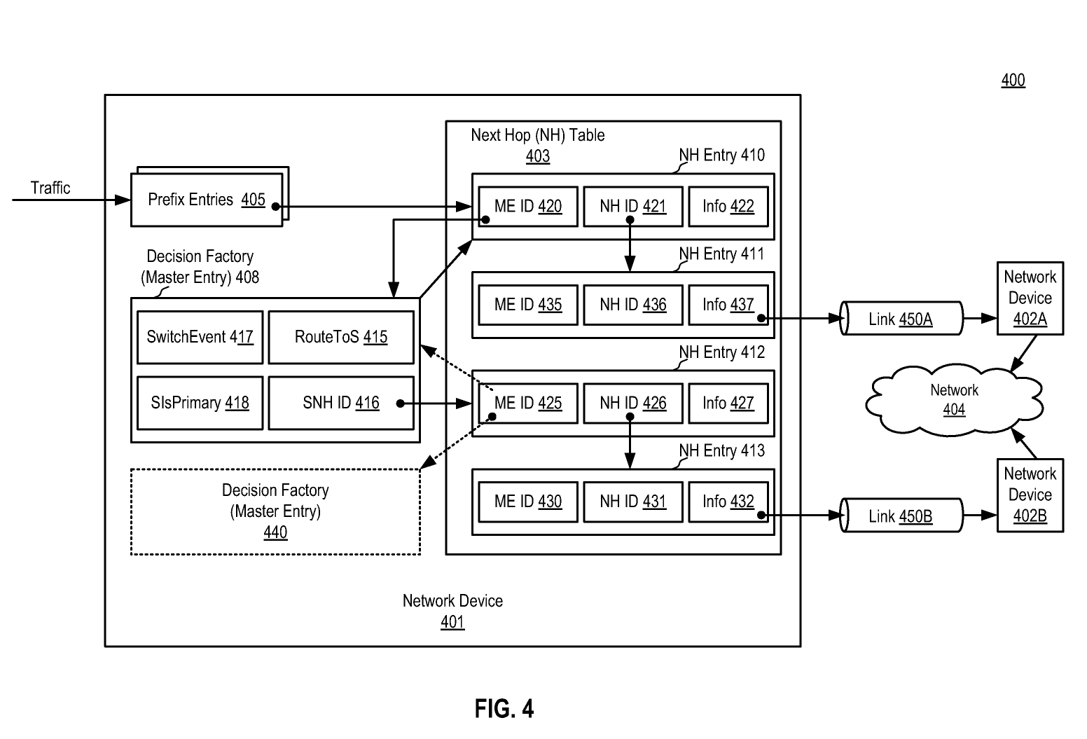

FIG. 4 is a block diagram illustrating network 400 according to one embodiment. Network 400 includes network device 401 communicatively coupled to network devices 402A-402B via links 450A-450B, respectively. Network devices 402A-402B are communicatively coupled to network 404. Thus, for example, subscriber traffic can enter network device 401 “from the left” and exits “to the right” and propagates towards the Internet. In one embodiment, network device 401 can be implemented as an instance of network device 301.

According to one embodiment, network device 401 includes a plurality of prefix entries 405, wherein each prefix entry of prefix entries 405 includes information for associating incoming traffic to a NH entry. For example, a prefix entry may include an Internet Protocol (IP) prefix and a reference (e.g., a pointer) to a NH entry. In such an example, when the destination IP address of the incoming traffic falls within the prefix of a prefix entry, the traffic is associated with the NH entry that is referenced by that prefix entry. Here, associating incoming traffic with a NH entry means that the traffic shall be processed based on the NH entry.

Network device 401 includes NH table 403, which can be implemented as part of a routing information base (RIB) of a control plane, a forwarding information base (FIB) or label forwarding information base (LFIB) of a forwarding plane. NH table 403 can be, however, implemented as part of any routing or forwarding table without departing from the broader scope and spirit of the present invention.

NH table 403 includes, but not limited to, NH entries, which can either be a CNH entry or a non-CNH. In one embodiment, one or more NH entries include a reference that points/maps to a master entry. In the illustrated example, NH entries 410 and 412 include master entry identifiers (ME IDs) 420 and 425, respectively, that reference master entry 408. It shall be understood, however, that the NH entries can reference different master entries. For example, ME ID 425 of NH entry 412 can reference master entry 440, instead of master entry 408.

Each non-CNH entry includes a reference to another NH entry. For example, NH entry 410 includes NH ID 421 that references NH entry 411, and NH entry 412 includes NH ID 426 that references NH entry 413. Each CNH entry includes information that enables network device 401 to direct (e.g., route/forward) traffic to a connected device. The information may, for example, be an outgoing multiprotocol label switching (MPLS) label, an IP address, a Media Access Control (MAC) address, an egress port identifier (ID), or any combination thereof. It shall be understood that other information can be included without departing from the broader scope and spirit of the present invention. For example, NH entry 411 includes info 437 which enables network device 401 to direct traffic towards network device 402A via link 450A, and NH entry 413 includes info 432 which enables network device 401 to direct traffic towards network device 402B via link 450B. In an embodiment where NH entries 410 and 412 are non-CNH entries, info 422 and 427 of NH entries 410 and 412, respectively, may include null information (e.g., 0) to indicate that they are not to be applied because NH entries 410 and 412 are non-CNH entries. Alternatively, info 422 and 427 of non-NH entries 410 and 412, respectively, may include non-null values (e.g., info 422 and/or 427 may include a service label). In an embodiment where NH entries 411 and 413 are CNH entries, ME IDs 435 and 430 of NH entries 411 and 413, respectively, may include null information (e.g., 0) to indicate that they are not to be applied because NH entries 411 and 413 are CNH entries. Alternatively, ME IDs 435 and 430 of CNH entries 411 and 413, respectively, may include non-null information in order to reduce the number of NH entries.

Network device 401 includes master entries 408 and 440. More or less master entries, however, can be included as part of device 401. In one embodiment, master entry 408 includes RouteToS 415, SNH ID 416, SwitchEvent 417, and SlsPrimary 418. In one embodiment, SwitchEvent 417 contains one or more predetermined conditions (e.g., a link failure). RouteToS 415, in one embodiment, contains a Boolean value indicating whether traffic should be processed by a NH entry referenced by SNH ID 416, or processed by a NH entry that referenced master entry 408. For example, when RouteToS 415 contains a value TRUE, traffic is processed by the NH entry referenced by SHN ID 416, otherwise, traffic is processed by the NH entry that referenced master entry 408. Other conventions, however, can be used for implementing RouteToS 415.

SlsPrimary 418 contains a Boolean value indicating whether the NH entry referenced by SNH ID 416 is a primary or backup path (i.e., chain). For example, when SlsPrimary 418 contains a value TRUE, the chain referenced by SNH ID 416 is a primary path. Otherwise, the chain referenced by SNH ID 416 is a backup path. Typically, a forwarding plane differentiates between a primary and a backup chain. When a primary chain fails, traffic is switched to the backup chain. However, traffic is not supposed to be directed to the backup chain indefinitely. Rather, traffic should be switched back to the primary chain as soon as the primary chain recovers or a new primary chain has been formed. Thus, the value contained in SlsPrimary 418 determines whether traffic should continue to be processed by the chain referenced by SNH ID 416 after the switch event has been resolved or a new primary chain has been provisioned.

Master entry 440 includes fields similar to those included as part of master entry 408. For the sake of brevity, master entry 440 shall not be discussed in details.

An example of traffic flow through network device 401 shall now be described. Network device 401 receives traffic, and uses prefix entries 405 to map the traffic to NH entry 410. Network device 401 determines that NH entry 410 includes ME ID 420 that references master entry 408. SNH ID 416 references NH entry 412. In this example, assume that RouteToS 415 currently contains a value FALSE. Thus, the traffic is to be processed based on NH entry 410, instead of NH entry 412. NH entry 410 includes NH ID 421 that references NH entry 411 (e.g., NH entry 410 is a non-CNH). Thus, network device 401 uses NH entry 411 (which in this example is a CNH) to process the traffic. Info 437 contains information that causes network device 401 to direct traffic to network device 402A via link 450A. Accordingly, network device 401 directs the traffic to network device 402A.

Assume now that the event which is contained in SwitchEvent 417 has occurred. In response to this occurrence, network device 401 sets RouteToS 415 to TRUE. Subsequently, network device 401 receives traffic, and uses prefix entries 405 to map the traffic to NH entry 410. Network device 401 determines that NH entry 410 includes ME ID 420 that references master entry 408. Since RouteToS 415 currently contains a value TRUE, the traffic is to be processed based on NH entry 412, instead of NH entry 410. NH entry 412 includes NH ID 426 that references NH entry 413 (e.g., NH entry 412 is a non-CNH). Thus, network device 401 uses NH entry 413 (which in this example is a CNH) to process the traffic. Info 432 contains information that causes network device 401 to direct traffic to network device 402B via link 450B. Accordingly, network device 401 directs the traffic to network device 402B after the switch event contained in SwitchEvent 417 is detected. Note that in this example, NH entry 412 can either not contain any reference to any master entry. Alternatively, NH entry 412 can contain a reference to a master entry. For example, ME ID 425 may reference master entry 408. But since SNH ID 416 references back to NH entry 412, the traffic would still be directed to network device 402B based on info 432.

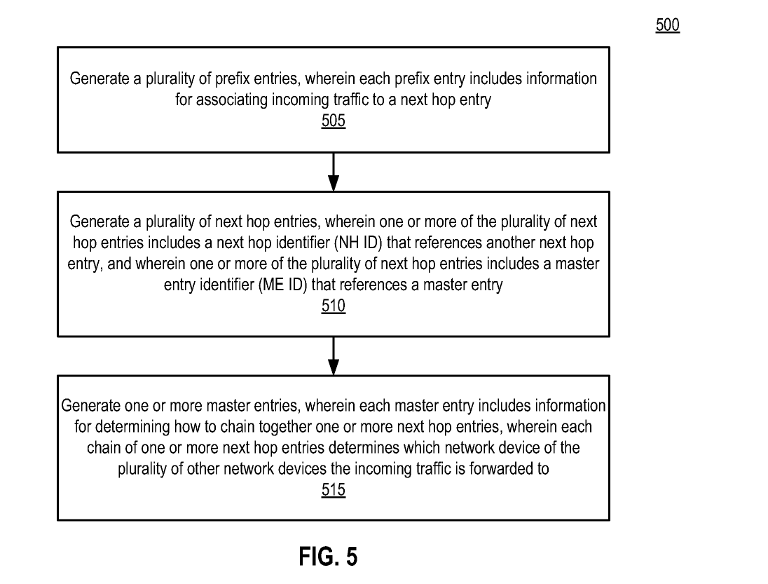

FIG. 5 is a flow diagram illustrating method 500 for providing a fast re-convergence of NH chains according to one embodiment. For example, method 500 can be performed by network device 401. Method 500 can be implemented in software, firmware, hardware, or any combination thereof. The operations in this and other flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Referring now to FIG. 5. At block 505, a network device generates a plurality of prefix entries (e.g., prefix entries 405), wherein each prefix entry includes information for associating incoming traffic to a next hop entry (e.g., NH entry 410-413). At block 510, the network device generates a plurality of next hop entries (e.g., NH entry 410-413), wherein one or more of the plurality of next hop entries includes a next hop identifier (NH ID) (e.g., NH ID 421, NH ID 426) that references another next hop entry (e.g., NH entry 411 and 413, respectively), and wherein one or more of the plurality of next hop entries includes a master entry identifier (ME ID) (e.g., ME ID 420, ME ID 425) that references a master entry.

At block 515, the network device generates one or more master entries (e.g., master entry 408, master entry 440), wherein each master entry includes information (e.g., RouteToS 415, SNH ID 416, SwitchEvent 417, and SlsPrimary 418) for determining how to chain together one or more next hop entries, wherein each chain of one or more next hop entries determines which network device of the plurality of other network devices the incoming traffic is forwarded to.

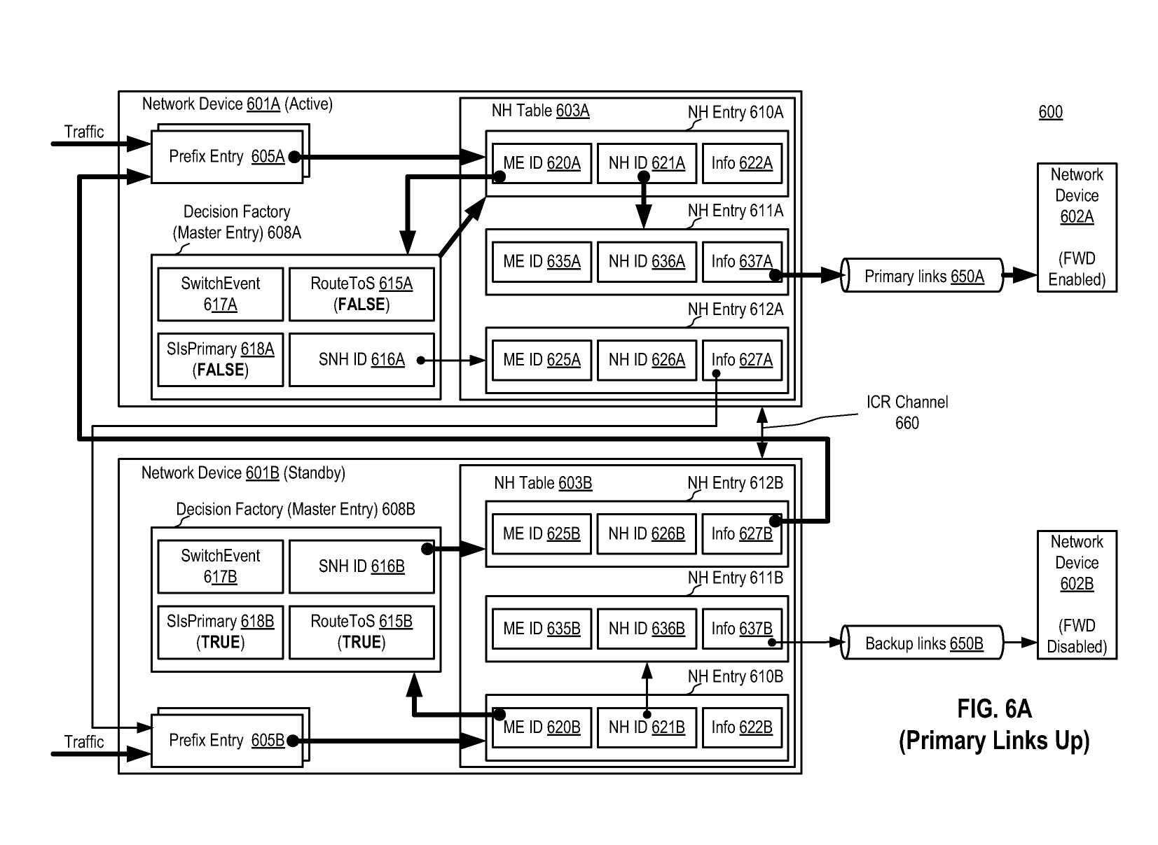

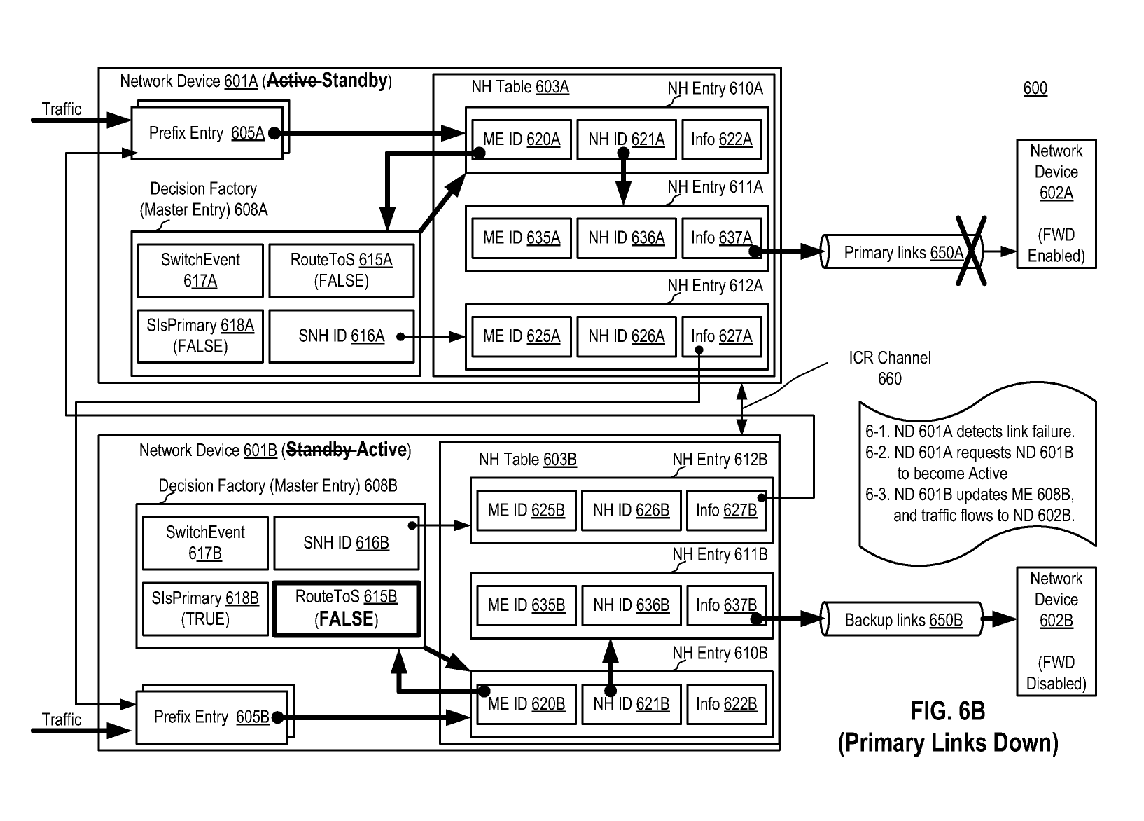

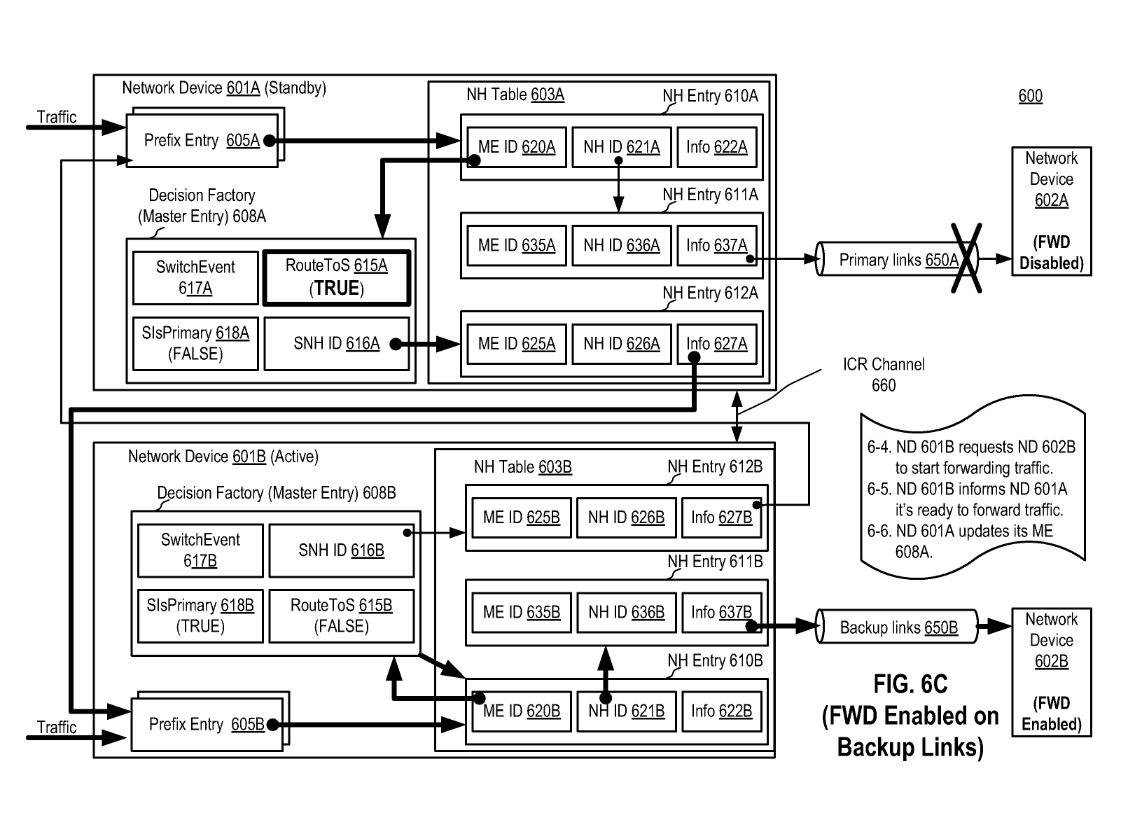

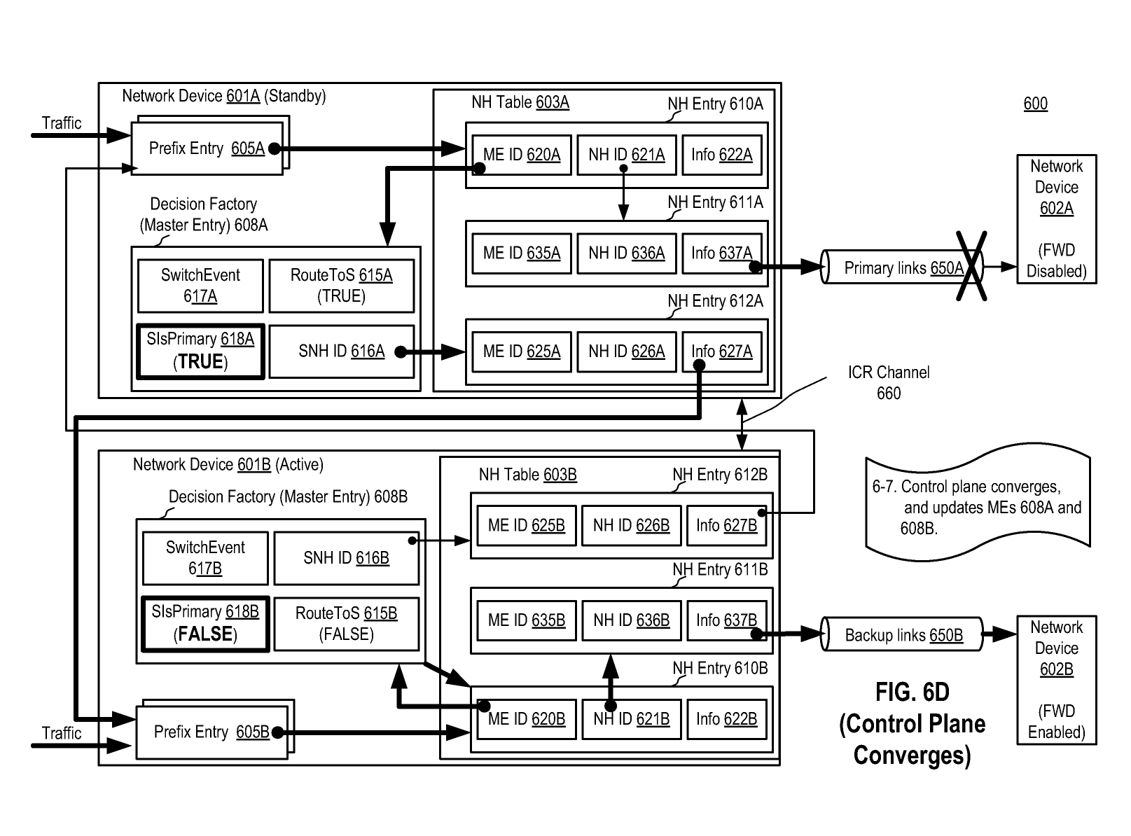

FIGS. 6A-6D are block diagrams illustrating network 600 comprising of network devices 601A and 601B communicatively coupled to each other. For example, network devices 601A and/or 601B may be an instance of network device 401. Network device 601A is communicatively coupled to network device 602A via primary links 650A, and network device 601B is communicatively coupled to network device 602B via backup links 650B.

Referring first to FIG. 6A. In this example, network devices 601A and 601B are implemented as part of an ICR system. Network devices 601A and 601B are currently configured to serve as the active and standby ICR device, respectively. Further, primary links 650A and 650B are currently in the active and standby state, respectively. As used herein, an “active” link refers to a link over which traffic can be forwarded, and a “standby” link refers to a link over which traffic cannot be forwarded. For example, network device 601A may have negotiated with network device 602A (e.g., using the Link Aggregation Control Protocol (LACP) protocol) to enable traffic forwarding by network device 602A. By way of further example, network device 601B may have negotiated with network device 602B (e.g., using the LACP protocol) to disable traffic forwarding by network device 602B.

Traffic flow through network device 601A shall now be described. Network device 601A receives traffic, and uses prefix entries 605A to map the traffic to NH entry 610A. Network device 601A determines that NH entry 610A includes ME ID 620A that references master entry 608A. SNH ID 616A references NH entry 612A. In this example, RouteToS 615A currently contains a value FALSE. Thus, the traffic is to be processed based on NH entry 610A, instead of NH entry 612A. NH entry 610A includes NH ID 621A that references NH entry 611A (e.g., NH entry 610A is a non-CNH). Thus, network device 601A uses NH entry 611A (which in this example is a CNH) to process the traffic. Info 637A contains information that causes network device 601A to direct traffic to network device 602A via link 650A. Accordingly, network device 601A directs the traffic to network device 602A.

Traffic flow through network device 601B shall now be described. Network device 601B receives traffic, and uses prefix entries 605B to map the traffic to NH entry 610B. Network device 601B determines that NH entry 610B includes ME ID 620B that references master entry 608B. SNH ID 616B references NH entry 612B. In this example, RouteToS 615B currently contains a value TRUE. Thus, the traffic is to be processed based on NH entry 612B, instead of NH entry 610B. Info 627B contains information that causes network device 601B to direct traffic to network device 601A. Accordingly, network device 601B directs the traffic to network device 601A. For example, standby ICR device 601B may be configured to direct traffic to active ICR device 601A because backup links 650B are in the standby state (i.e., network device 602B is not enabled to forward traffic).

Referring now to FIG. 6B. At transaction 6-1, network device 601A detects a link failure at primary links 650A. Thus, although traffic is received and directed to network device 602A, the traffic is lost because of the link failure. In response to detecting the link failure, network device 601A starts the process of redirecting the traffic to standby ICR device 601B. At transaction 6-2, network device 601A requests network device 601B to take over as the active ICR device (e.g., by sending one or more ICR message over ICR channel 660). Note that at this point, network device 601A has not yet reconfigured master entry 608A to cause traffic to be directed towards network device 601B because that would result in traffic propagating in an infinite loop between the two devices.

At transaction 6-3, in response to receiving the request from network device 601A, network device 601B reconfigures itself to become the active ICR device. As part of transaction 6-3, network device 601B also updates its master entry 608B to cause traffic to be directed towards network device 602B, instead of directing traffic to network device 601A. For example, network device 601B sets RouteToS 615B to be FALSE, causing its incoming traffic to be processed based on NH entry 610B, instead of NH entry 612B. NH entry 610B includes NH ID 621B that references NH entry 611B, which includes info 637B. Info 637B contains information that causes traffic to be directed to network device 602B via backup links 650B. Thus, after the update to master entry 608B, network device 601B directs its incoming traffic to network device 602B, instead of network device 601A.

Referring now to FIG. 6C. At transaction 6-4, network device 601B requests network device 602B to start forwarding traffic. For example, network device 601B may negotiate with network device 602B using the LACP protocol to enable forwarding at network device 602B. As part of transaction 6-4, network device 602B enables forwarding, and thus, backup links 650B are now in the active state.

At transaction 6-5, in response to determining backup links 650B are active, network device 601B informs network device 601A that network device 601B is ready to forward traffic to a network device other than network device 601A (e.g., by sending one or more ICR messages over ICR channel 660). At transaction 6-6, in response to receiving the indication that network device 601B is ready to forward traffic, network device 601A updates its master entry 608A. For example, network device 601A sets RouteToS 615A to be TRUE, causing its incoming traffic to be processed based on NH entry 612A (referenced by SNH ID 616A), instead of NH entry 610A. NH entry 612A includes info 627A which contains information that causes traffic to be directed to network device 601B. Thus, after the update to master entry 608A, network device 601A directs its incoming traffic to network device 601B, instead of network device 602B.

Referring now to FIG. 6D. At transaction 6-7, the control plane converges and updates master entries 608A and 608B. For example, the control plane sends information to network device 601A instructing network device 601A to set SlsPrimary 618A to be TRUE, and sends information to network device 601B instructing network device 601B to set SlsPrimary 618A to be FALSE. As used herein, a “control plane convergence” refers to the control plane becoming aware of the link failure, which is typically well after the forwarding plane has detected the failure and switched to the backup chain.

Each of SlsPrimary 618A and 618B contains a Boolean value indicating whether the NH entry referenced by SNH ID 616A and 616B, respectively, is a primary or backup path (i.e., chain). Typically, a forwarding plane differentiates between a primary and a backup chain. When a primary chain fails, traffic is switched to the backup chain. However, traffic is not supposed to be directed to the backup chain indefinitely. Rather, traffic should be switched back to the primary chain as soon as the primary chain recovers or a new primary chain has been formed. Thus, the operations of transaction 6-7 are optional, and only need to be performed if the control plane determines that network devices 601A and 601B should not switch back to their initial ICR states. In other words, once the control plane converges (i.e., becomes aware of the failure and switch over), it may decide to let traffic continue to be directed to network device 602B via network device 601B (i.e., the new active ICR device). If so, the control plane performs the operations of transaction 6-7. On the other hand, if the control plane determines that network devices 601A and 601B should switch back to their initial ICR roles once the link failure is resolved (or a new primary chain has been provisioned), then the control plane is not required to perform the operations of transaction 6-7.

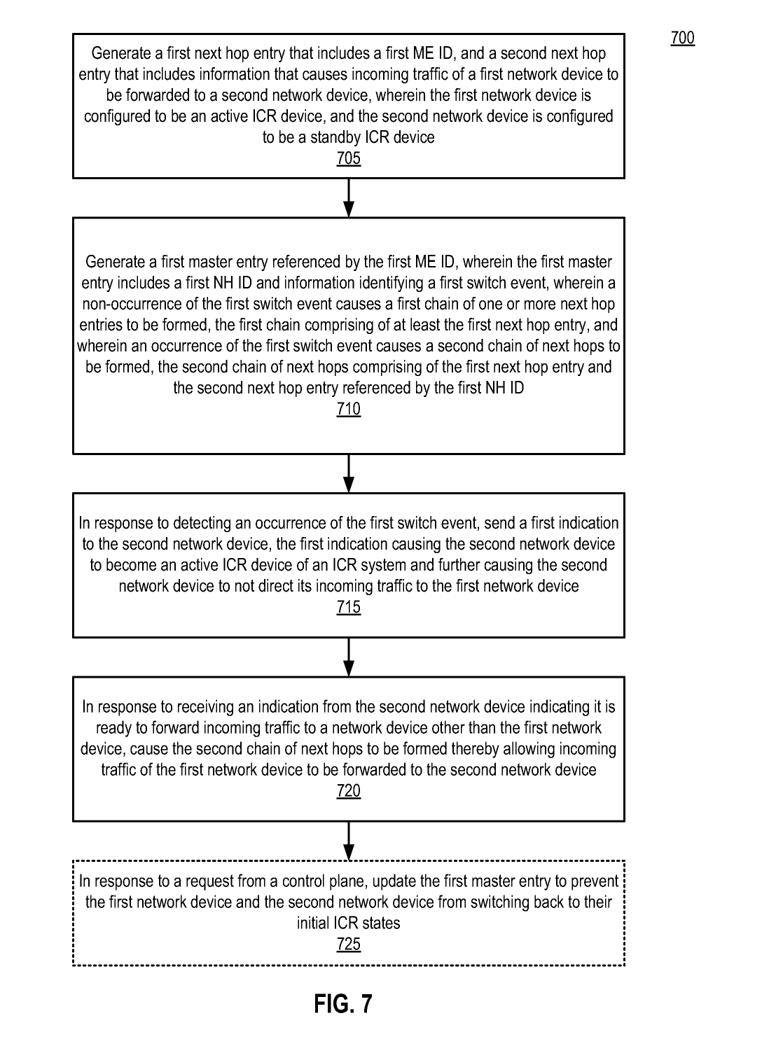

FIG. 7 is a flow diagram illustrating method 700 for providing a fast re-convergence of NH chains according to one embodiment. For example, method 700 can be performed by network device 601A. Method 700 can be implemented in software, firmware, hardware, or any combination thereof.

Referring now to FIG. 7. At block 705, a first network device generates a first next hop entry (e.g., NH entry 610A) that includes a first ME ID (e.g., ME ID 620A), and a second next hop entry (e.g., NH entry 612A) that includes information (e.g., info 627A) that causes incoming traffic of the first network device (e.g., network device 601A) to be forwarded to a second network device (e.g., network device 601B), wherein the first network device is configured to be an active ICR device, and the second network device is configured to be a standby ICR device.

At block 710, the first network device generates a first master entry (e.g., master entry 608A) referenced by the first ME ID, wherein the first master entry includes a first NH ID (e.g., SNH ID 616A) and information identifying a first switch event (e.g., information contained in SwitchEvent 617A), wherein a non-occurrence of the first switch event causes a first chain of one or more next hop entries to be used, the first chain comprising of at least the first next hop entry, and wherein an occurrence of the first switch event causes a second chain of next hops to be used, the second chain of next hops comprising of the first next hop entry and the second next hop entry referenced by the first NH ID.

At block 715, the first network device in response to detecting an occurrence of the first switch event (e.g., as part of transaction 6-1), sends a first indication to the second network device (e.g., as part of transaction 6-2), the first indication causing the second network device to become an active ICR device of an ICR system and further causing the second network device to not direct its incoming traffic to the first network device (e.g., as part of transaction 6-3).

At block 720, the first network device in response to receiving an indication from the second network device indicating it is ready to forward incoming traffic to a network device other than the first network device (e.g., as part of transaction 6-5), causes the second chain of next hops to be used (e.g., as part of transaction 6-6) thereby allowing incoming traffic of the first network device to be forwarded to the second network device.

At block 725, the first network device in response to a request from a control plane, updates the first master entry to synchronize it with the new ICR state (e.g., as part of transaction 6-7).

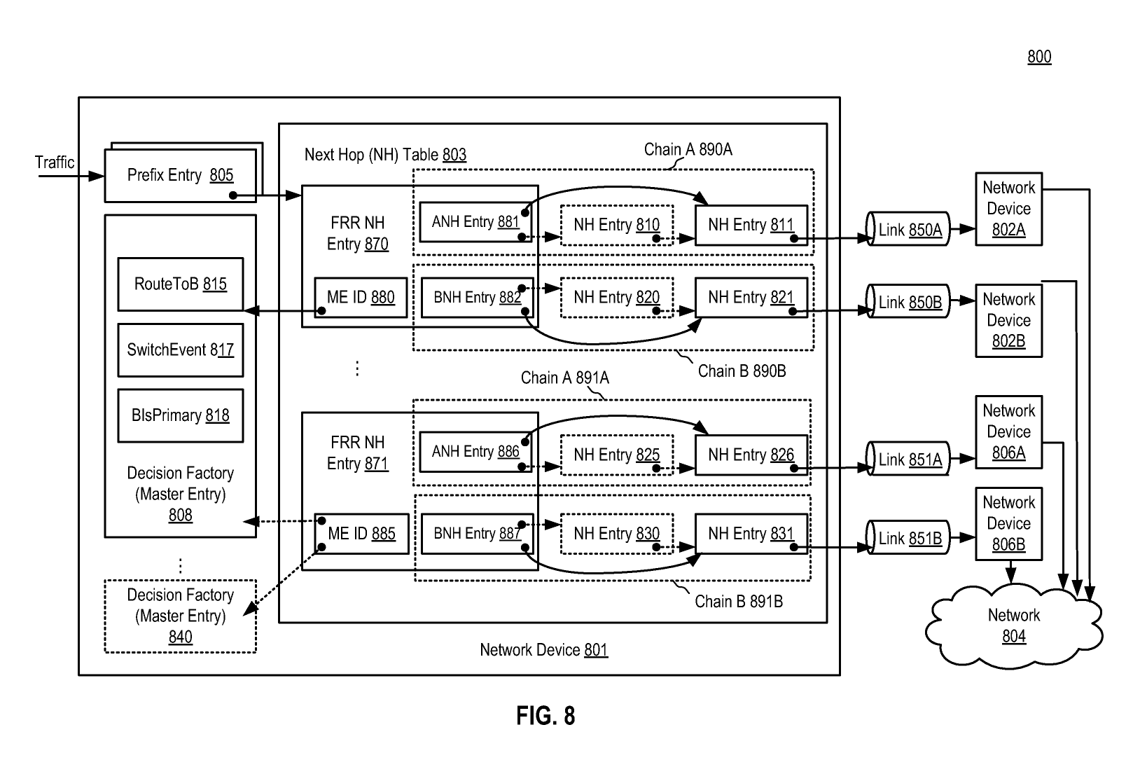

FIG. 8 is a block diagram illustrating network 800 according to one embodiment. Network 800 includes network device 801 communicatively coupled to network devices 802A-802B via links 850A-850B, respectively, and communicatively coupled to network devices 806A-806B via links 851A-851B, respectively. Network devices 802A-802B and 806A-806B are communicatively coupled to network 804. Thus, for example, traffic can enter network device 801 “from the left” and exits “to the right”. In one embodiment, network device 801 can be implemented as an instance of network device 201.

According to one embodiment, network device 801 includes a plurality of prefix entries 805, wherein each prefix entry of prefix entries 805 includes information for associating incoming traffic to a FRR NH entry. For example, a prefix entry may include an Internet Protocol (IP) prefix and a reference (e.g., a pointer) to a FRR NH entry. In such an example, when the destination (and/or source) IP address of the incoming traffic falls within the prefix of a prefix entry, the traffic is associated with the FRR NH entry that is referenced by that prefix entry. Here, associating incoming traffic with a FRR NH entry means that the traffic shall be processed based on the FRR NH entry.

Network device 801 includes NH table 803, which can be implemented as part of a routing information base (RIB) of a control plane, a forwarding information base (FIB) or label forwarding information base (LFIB) of a forwarding plane. NH table 803 can be, however, implemented as part of any routing or forwarding table without departing from the broader scope and spirit of the present invention.

In one embodiment, NH table 803 includes, but not limited to, FRR NH entries. In one embodiment, one or more FRR NH entries include a reference that points/maps to a master entry. In the illustrated example, FRR NH entry 870 includes ME ID 880 that references master entry 808. FRR NH entry 871 includes ME ID 885 that may reference the same or a different master entry (e.g., master entry 840).

According to one embodiment, each FRR NH entry includes a reference that points to a first “A” chain of one or more NH entries, and a reference that points to a second “B” chain of one or more NH entries. Either chain “A” or chain “B” can be configured as the primary chain (described in further details below). In the illustrated example, FRR NH entry 870 includes chain “A” 890A and chain “B” 890B. Chain A 890A includes “A” next hop (ANH) entry 881 that references NH entry 810, which in turn references NH entry 811. NH entry 811 contains information that causes network device 801 to direct traffic to network device 802A via link 850A. Further, Chain “B” 890B includes “B” next hop (BNH) entry 882 that references NH entry 820, which in turn references NH entry 821 (which make up chain “B” of FRR NH entry 870). NH entry 821 contains information that causes network device 801 to direct traffic to network device 802B via link 850B.

In the illustrated example, FRR NH entry 871 includes chain “A” 891A and chain “B” 891B. Chain “A” 891A includes ANH entry 886 that references NH entry 825, which in turn references NH entry 826 (which make up chain “A” of FRR NH entry 871). NH entry 826 contains information that causes network device 801 to direct traffic to network device 806A via link 851A. Further, chain “B” 891B includes BNH entry 887 that references NH entry 830, which in turn references NH entry 831 (which make up chain “B” of FRR NH entry 871). NH entry 831 contains information that causes network device 801 to direct traffic to network device 806B via link 851B.

The NH entries illustrated in FIG. 8 are implemented similar to the NH entries illustrated in FIG. 4. For the sake of brevity, the NH entries will not be discussed in further details here.

Network device 801 includes master entries 808 and 840. More or less master entries, however, can be included as part of device 801. Master entry 808 includes information which enable network device 801 to determine whether to process the traffic using the FRR NH entry's chain “A” or chain “B”. In one embodiment, master entry 808 includes RouteToB 815, SwitchEvent 817, and BlsPrimary 818. In one embodiment, SwitchEvent 817 contains one or more predetermined conditions (e.g., a link failure). RouteToB 815, in one embodiment, contains a Boolean value indicating whether traffic should be processed by the “B” chain. For example, when RouteToB 815 contains a value TRUE, traffic is processed by the “B” chain, otherwise, traffic is processed by the “A” chain. Other conventions, however, can be used for implementing RouteToB 815.

BlsPrimary 818 contains a Boolean value indicating whether the chain referenced by the BNH entry (i.e., the “B” chain) is the primary chain. For example, when BlsPrimary 818 contains a value TRUE, the chain referenced by the BNH entry is a primary path. Otherwise, the chain referenced by the BNH entry is a backup path. Typically, a forwarding plane differentiates between a primary and a backup chain. When a primary chain fails, traffic is switched to the backup chain. However, traffic is not supposed to be directed to the backup chain indefinitely. Rather, traffic should be switched back to the primary chain as soon as the primary chain recovers or a new primary chain has been formed. Thus, the value contained in BlsPrimary 818 determines whether traffic should continue to be processed by the “B” chain after the switch event has been resolved or a new chain “A” has been provisioned.

Master entry 840 includes fields similar to those included as part of master entry 808. For the sake of brevity, master entry 840 shall not be discussed in details.

An example of traffic flow through network device 801 shall now be described. Network device 801 receives traffic, and uses prefix entries 805 to map the traffic to FRR NH entry 870. Network device 801 determines that NH entry 870 includes ME ID 880 that references master entry 808. In this example, assume that RouteToB 815 currently contains a value FALSE. Thus, the traffic is to be processed based on ANH entry 881, instead of BNH entry 882. NH entry 881 includes a pointer that references NH entry 811 (e.g., NH entry 881 is a non-CNH). Thus, network device 801 uses NH entry 811 (which in this example is a CNH) to process the traffic. NH entry 811 contains information that causes network device 801 to direct traffic to network device 802A via link 850A. Accordingly, network device 801 directs the traffic to network device 802A.

Assume now that the event which is contained in SwitchEvent 817 has occurred. In response to this occurrence, network device 801 sets RouteToB 815 to TRUE. Subsequently, network device 801 receives traffic, and uses prefix entries 805 to map the traffic to FRR NH entry 870. Network device 801 determines that FRR NH entry 870 includes ME ID 880 that references master entry 808. Since RouteToB 815 currently contains a value TRUE, the traffic is to be processed based on BNH entry 882, instead of ANH entry 881. BNH entry 882 contains a pointer/ID that references NH entry 821 (e.g., BNH entry 882 is a non-CNH). Thus, network device 801 uses NH entry 821 (which in this example is a CNH) to process the traffic. NH entry 821 contains information that causes network device 801 to direct traffic to network device 802B via link 850B. Accordingly, network device 801 directs the traffic to network device 802B after the switch event contained in SwitchEvent 817 is detected.

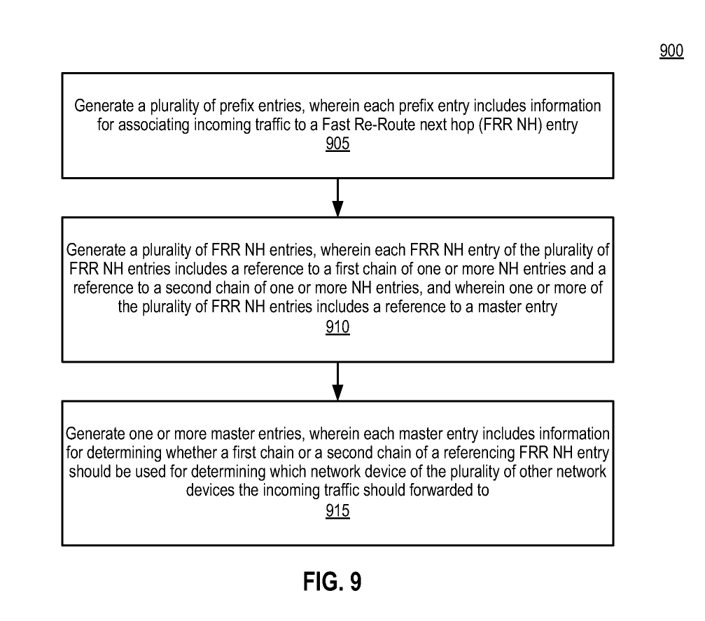

FIG. 9 is a flow diagram illustrating method 900 for providing a fast re-convergence of NH chains according to one embodiment. For example, method 900 can be performed by network device 801. Method 900 can be implemented in software, firmware, hardware, or any combination thereof. Referring now to FIG. 9. Method 900 assumes a first network device is communicatively coupled to a plurality of other network devices in a network. At block 905, a network device generates a plurality of prefix entries (e.g., prefixes 805), wherein each prefix entry includes information for associating incoming traffic to a Fast Re-Route next hop (FRR NH) entry (e.g., FRR NH entry 870, FRR NH entry 871).

At block 910, the network device generates a plurality of FRR NH entries, wherein each FRR NH entry of the plurality of FRR NH entries includes a reference (e.g., ANH entry 881) to a first chain (e.g., chain “A” 890A) of one or more NH entries (e.g., ANH entry 881, NH entries 810-811) and a reference (e.g., BNH entry 882) to a second chain (e.g., chain “B” 890B) of one or more NH entries (e.g., BNH entry 882, NH entries 820-821), and wherein one or more of the plurality of FRR NH entries includes a reference (e.g., ME ID 880) to a master entry (e.g., master entry 808).

At block 915, the network device generates one or more master entries, wherein each master entry includes information (e.g., RouteToB 815, SwitchEvent 817) for determining whether a first chain or a second chain of a referencing FRR NH entry (e.g., FRR NH entry 870) should be used for determining which network device (e.g., network devices 802A-802B) of the plurality of other network devices the incoming traffic should forwarded to.

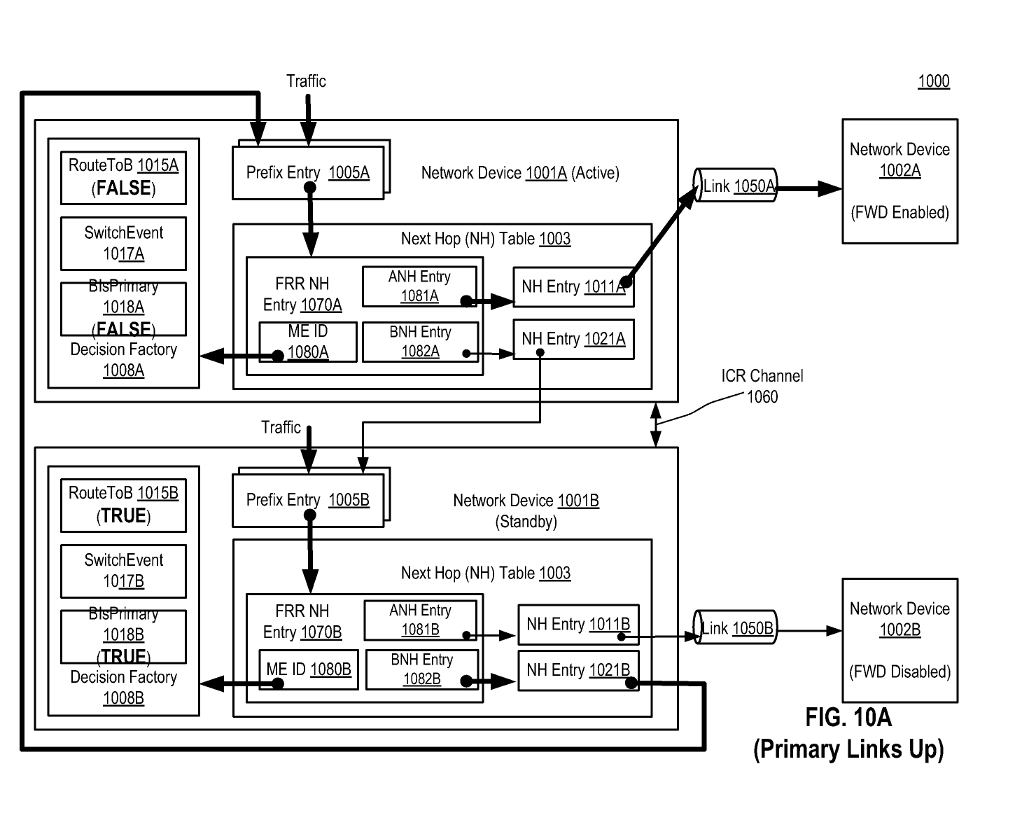

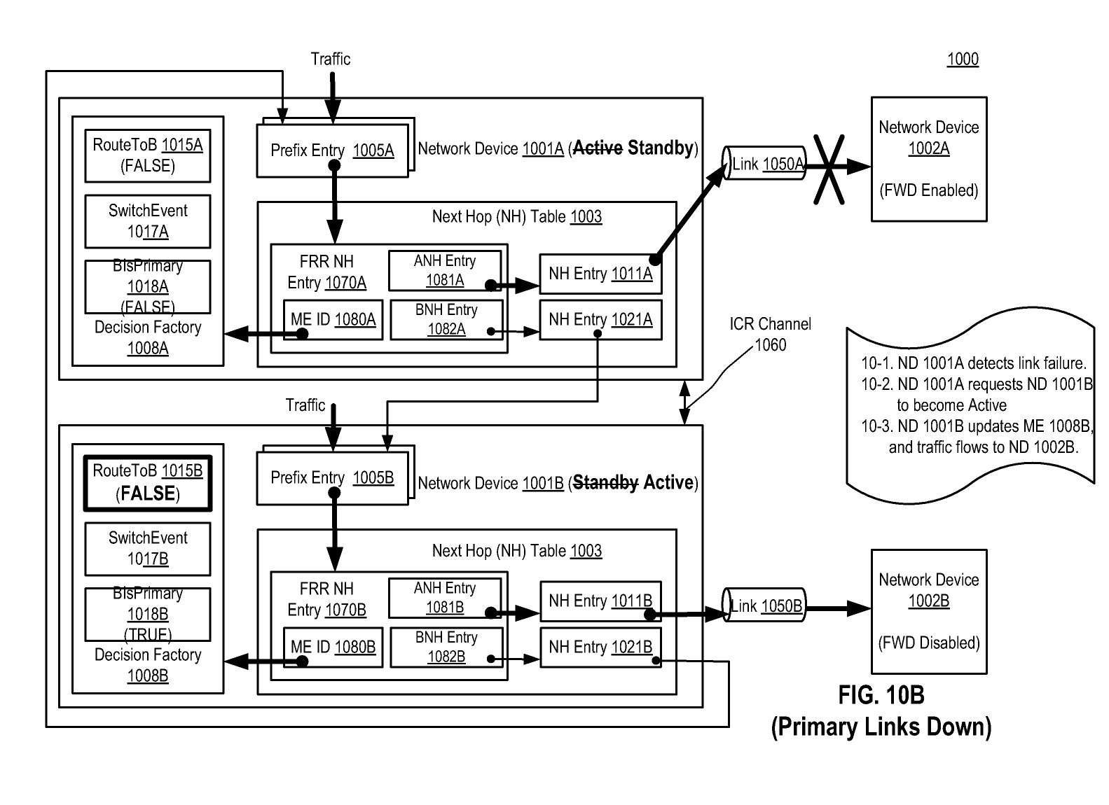

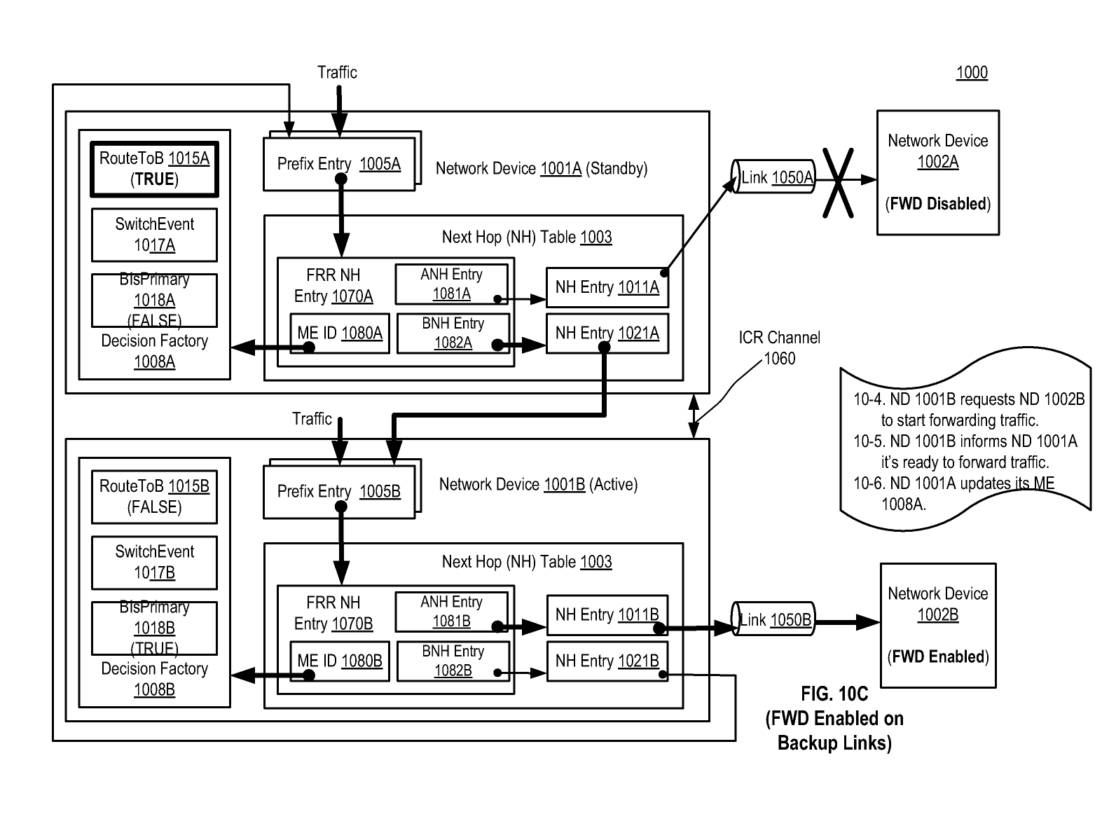

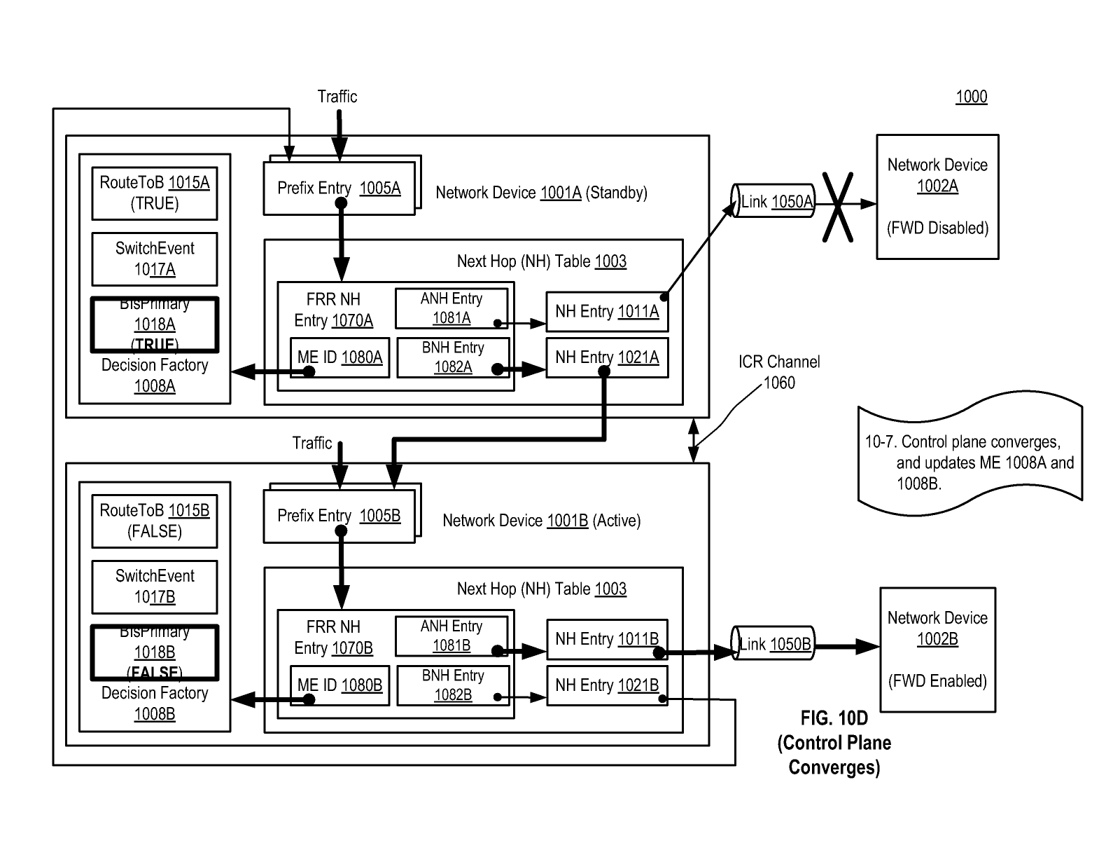

FIGS. 10A-10D are block diagrams illustrating network 1000 comprising of network devices 1001A and 1001B communicatively coupled to each other. For example, network devices 1001A and/or 1001B may be an instance of network device 801. Network device 1001A is communicatively coupled to network device 1002A via primary links 1050A, and network device 1001B is communicatively coupled to network device 1002B via primary links 1050B.

Referring first to FIG. 10A. In this example, network devices 1001A and 1001B are implemented as part of an ICR system. Network devices 1001A and 1001B are currently configured to serve as the active and standby ICR device, respectively. Further, primary links 1050A and 1050B are currently in the active and standby state, respectively. As used herein, an “active” link refers to a link over which traffic can be forwarded, and a “standby” link refers to a link over which traffic cannot be forwarded. For example, network device 1001A may have negotiated with network device 1002A (e.g., using the Link Aggregation Control Protocol (LACP) protocol) to enable traffic forwarding by network device 1002A. By way of further example, network device 1001B may have negotiated with network device 1002B (e.g., using the LACP protocol) to disable traffic forwarding by network device 1002B.

Traffic flow through network device 1001A shall now be described. Network device 1001A receives traffic, and uses prefix entries 1005A to map the traffic to FRR NH entry 1070A. Network device 1001A determines that NH entry 1070A includes ME ID 1080A that references master entry 1008A. In this example, assume that RouteToB 1015A currently contains a value FALSE. Thus, the traffic is to be processed based on ANH entry 1081A, instead of BNH entry 1082A. NH entry 1081A includes a pointer that references NH entry 1011A (e.g., NH entry 1081A is a non-CNH). Thus, network device 1001A uses NH entry 1011A (which in this example is a CNH) to process the traffic. NH entry 1011A contains information that causes network device 1001A to direct traffic to network device 1002A via link 1050A. Accordingly, network device 1001A directs the traffic to network device 1002A.

Traffic flow through network device 1001B shall now be described. Network device 1001B receives traffic, and uses prefix entries 1005B to map the traffic to FRR NH entry 1070B. Network device 1001B determines that NH entry 1070B includes ME ID 1080B that references master entry 1008B. In this example, assume that RouteToB 1015B currently contains a value TRUE. Thus, the traffic is to be processed based on BNH entry 1082B, instead of ANH entry 1081B. NH entry 1082B includes a pointer that references NH entry 1021B (e.g., NH entry 1082B is a non-CNH). Thus, network device 1001B uses NH entry 1021B (which in this example is a CNH) to process the traffic. NH entry 1021B contains information that causes network device 1001B to direct traffic to network device 1001A. Accordingly, network device 1001B directs the traffic to network device 1001A.

Referring now to FIG. 10B. At transaction 10-1, network device 1001A detects a link failure at primary links 1050A. Thus, although traffic is received and directed to network device 1002A, the traffic is lost because of the link failure. In response to detecting the link failure, network device 1001A starts the process of redirecting the traffic to standby ICR device 1001B. At transaction 10-2, network device 1001A requests network device 1001B to take over as the active ICR device (e.g., by sending one or more ICR message over ICR channel 1060). Note that at this point, network device 1001A has not yet reconfigured master entry 1008A to cause traffic to be directed towards network device 1001B because that would result in traffic propagating in an infinite loop between the two devices.

At transaction 10-3, in response to receiving the request from network device 1001A, network device 1001B reconfigures itself to become the active ICR device. As part of transaction 10-3, network device 1001B also updates its master entry 1008B to cause traffic to be directed towards network device 1002B, instead of directing traffic to network device 1001A. For example, network device 1001B sets RouteToB 1015B to be FALSE, causing its incoming traffic to be processed based on ANH entry 1081B, instead of BNH entry 1082B. ANH entry 1081B includes information that references NH entry 1011B, which contains information that causes traffic to be directed to network device 1002B via backup links 1050B. Thus, after the update to master entry 1008B, network device 1001B directs its incoming traffic to network device 1002B, instead of network device 1001A.

Referring now to FIG. 10C. At transaction 10-4, network device 1001B requests network device 1002B to start forwarding traffic. For example, network device 1001B may negotiate with network device 1002B using the LACP protocol to enable forwarding at network device 1002B. As part of transaction 10-4, network device 1002B enables forwarding, and thus, backup links 1050B are now in the active state.

At transaction 10-5, in response to determining backup links 1050B are active, network device 1001B informs network device 1001A that network device 1001B is ready to forward traffic to a network device other than network device 1001A (e.g., by sending one or more ICR messages over ICR channel 1060). At transaction 10-6, in response to receiving the indication that network device 1001B is ready to forward traffic, network device 1001A updates its master entry 1008A. For example, network device 1001A sets RouteToB 1015A to be TRUE, causing its incoming traffic to be processed based on BNH entry 1082A, instead of ANH entry 1081A. BNH entry 1082A contains information that references NH entry 1021A, which contains information that causes traffic to be directed to network device 1001B. Thus, after the update to master entry 1008A, network device 1001A directs its incoming traffic to network device 1001B, instead of network device 1002B.

Referring now to FIG. 10D. At transaction 10-7, the control plane converges and updates master entries 1008A and 1008B. For example, the control plane sends information to network device 1001A instructing network device 1001A to set BlsPrimary 1018A to be TRUE, and sends information to network device 1001B instructing network device 1001B to set BlsPrimary 1018A to be FALSE.

Each of BlsPrimary 1018A and 1018B contains a Boolean value indicating whether the chain referenced by BHN entry 1082A and 1082B, respectively, is a primary path/chain. Typically, a forwarding plane differentiates between a primary and a backup chain. When a primary chain fails, traffic is switched to the backup chain. However, traffic is not supposed to be directed to the backup chain indefinitely. Rather, traffic should be switched back to the primary chain as soon as the primary chain recovers or a new primary chain has been formed. Thus, the operations of transaction 10-7 are optional, and only need to be performed if the control plane determines that network devices 1001A and 1001B should not switch back to their initial ICR states. In other words, once the control plane converges (i.e., becomes aware of the failure and switch over), it may decide to let traffic continue to be directed to network device 1002B via network device 1001B (i.e., the new active ICR device). If so, the control plane performs the operations of transaction 10-7. On the other hand, if the control plane determines that network devices 1001A and 1001B should switch back to their initial ICR roles once the link failure is resolved (or a new primary chain has been provisioned), then the control plane is not required to perform the operations of transaction 10-7.

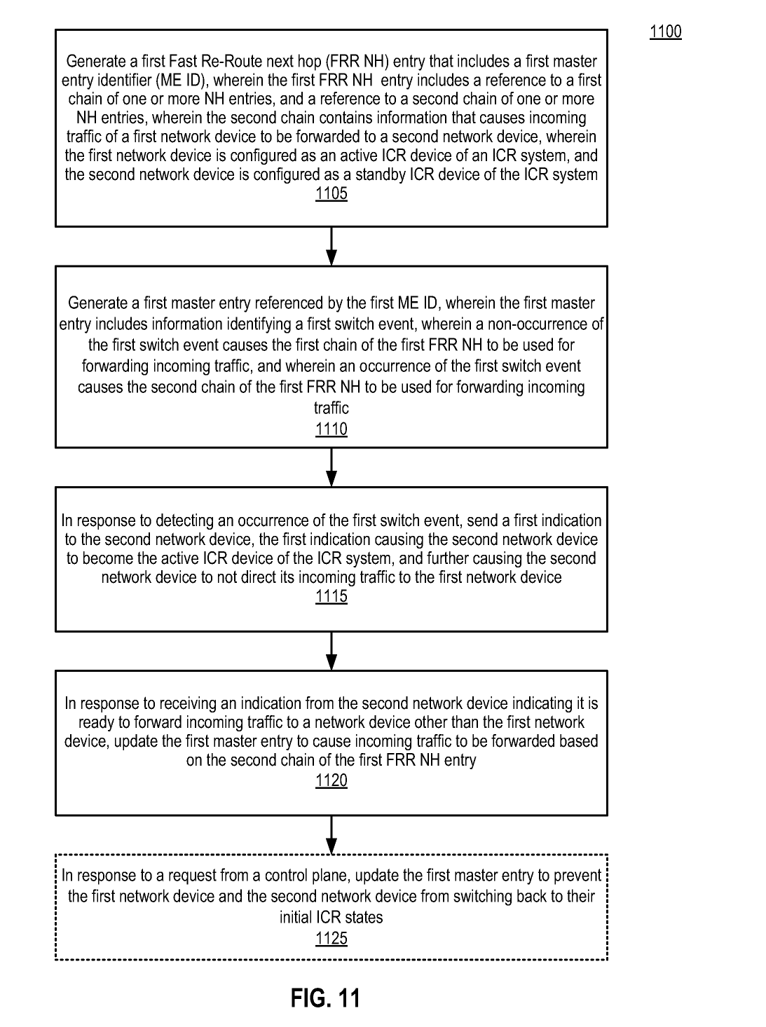

FIG. 11 is a flow diagram illustrating method 1100 for providing a fast re-convergence of NH chains according to one embodiment. For example, method 1100 can be performed by network device 1001A. Method 1100 can be implemented in software, firmware, hardware, or any combination thereof.

Referring now to FIG. 11. At block 1105, a first network device generates a first Fast Re-Route next hop (FRR NH) entry (e.g., FRR NH entry 1070A) that includes a first master entry identifier (ME ID) (e.g., ME ID 1080A), wherein the first FRR NH entry includes a reference to a first chain of one or more NH entries (e.g., ANH entry 1081A, NH entry 1011A), and a reference to a second chain of one or more NH entries (e.g., BNH entry 1082A, NH entry 1021A), wherein the second chain contains information that causes incoming traffic of the first network device (e.g., network device 1001A) to be forwarded to a second network device (e.g., network device 1001B), wherein the first network device is configured as an active ICR device of an ICR system, and the second network device is configured as a standby ICR device of the ICR system.

At block 1110, the first network device generates a first master entry (e.g., master entry 1008A) referenced by the first ME ID, wherein the first master entry includes information (e.g., SwitchEvent 1017A) identifying a first switch event, wherein a non-occurrence of the first switch event causes the first chain of the first FRR NH to be used for forwarding incoming traffic, and wherein an occurrence of the first switch event causes the second chain of the first FRR NH to be used for forwarding incoming traffic.

At block 1115, the first network device in response to detecting an occurrence of the first switch event (e.g., as part of transaction 10-1), sends a first indication to the second network device (e.g., as part of transaction 10-2), the first indication causing the second network device to become the active ICR device of the ICR system, and further causing the second network device to not direct its incoming traffic to the first network device (e.g., as part of transaction 10-3).

At block 1120, the first network device in response to receiving an indication from the second network device (e.g., as part of transaction 10-5) indicating it is ready to forward incoming traffic to a network device other than the first network device, update the first master entry to cause incoming traffic to be forwarded based on the second chain of the first FRR NH entry (e.g., as part of transaction 10-6).

At block 1125, the first network device in response to a request from a control plane, updates the first master entry to synchronize it with the new ICR state (e.g., as part of transaction 10-7).

An electronic device or a computing device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

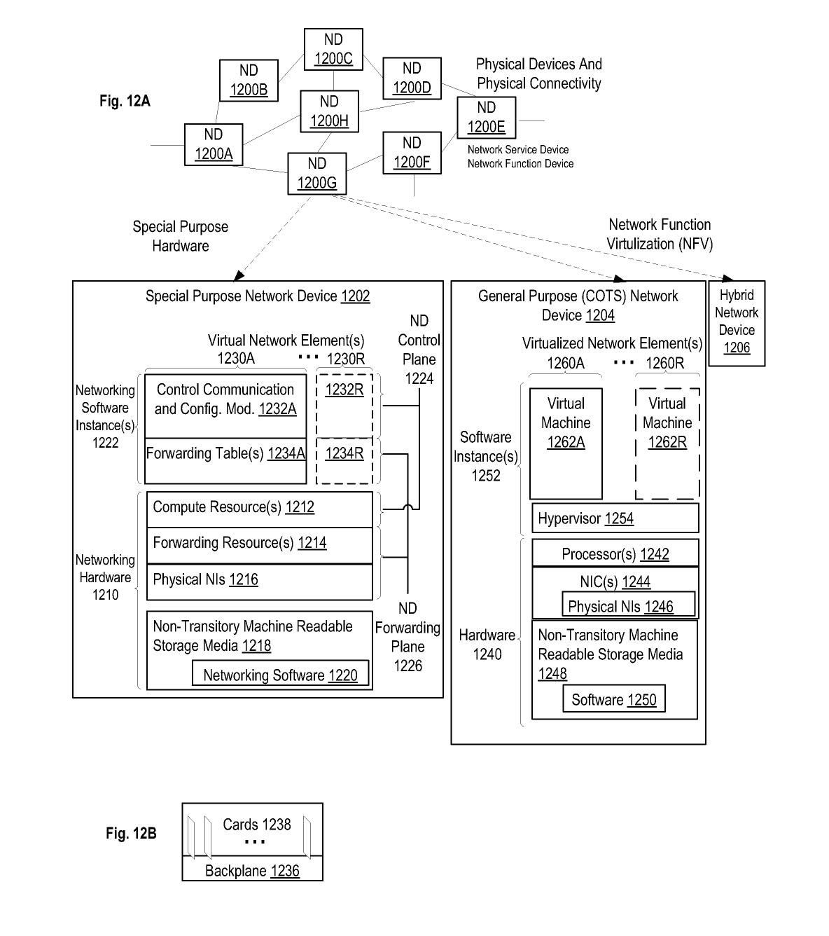

FIG. 12A illustrates connectivity between network devices (NDs) within an exemplary network, as well as three exemplary implementations of the NDs, according to some embodiments of the invention. FIG. 12A shows NDs 1200A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 1200A, E, and F illustrates that these NDs act as ingress and egress points for the network (and thus, these NDs are sometimes referred to as edge NDs; while the other NDs may be called core NDs).

Two of the exemplary ND implementations in FIG. 12A are: 1) a special-purpose network device 1202 that uses custom application-specific integrated-circuits (ASICs) and a proprietary operating system (OS); and 2) a general purpose network device 1204 that uses common off-the-shelf (COTS) processors and a standard OS.

The special-purpose network device 1202 includes networking hardware 1210 comprising compute resource(s) 1212 (which typically include a set of one or more processors), forwarding resource(s) 1214 (which typically include one or more ASICs and/or network processors), and physical network interfaces (NIs) 1216 (sometimes called physical ports), as well as non-transitory machine readable storage media 1218 having stored therein networking software 1220. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 1200A-H. During operation, the networking software 1220 may be executed by the networking hardware 1210 to instantiate a set of one or more networking software instance(s) 1222. Each of the networking software instance(s) 1222, and that part of the networking hardware 1210 that executes that network software instance (be it hardware dedicated to that networking software instance and/or time slices of hardware temporally shared by that networking software instance with others of the networking software instance(s) 1222), form a separate virtual network element 1230A-R. Each of the virtual network element(s) (VNEs) 1230A-R includes a control communication and configuration module 1232A-R (sometimes referred to as a local control module or control communication module) and forwarding table(s) 1234A-R, such that a given virtual network element (e.g., 1230A) includes the control communication and configuration module (e.g., 1232A), a set of one or more forwarding table(s) (e.g., 1234A), and that portion of the networking hardware 1210 that executes the virtual network element (e.g., 1230A).

Software 1220 can include code which be executed by networking hardware 1210, cause networking hardware 1210 to perform operations of one or more embodiments of the present invention as part networking software instances 1222.

The special-purpose network device 1202 is often physically and/or logically considered to include: 1) a ND control plane 1224 (sometimes referred to as a control plane) comprising the compute resource(s) 1212 that execute the control communication and configuration module(s) 1232A-R; and 2) a ND forwarding plane 1226 (sometimes referred to as a forwarding plane, a data plane, or a media plane) comprising the forwarding resource(s) 1214 that utilize the forwarding table(s) 1234A-R and the physical NIs 1216. By way of example, where the ND is a router (or is implementing routing functionality), the ND control plane 1224 (the compute resource(s) 1212 executing the control communication and configuration module(s) 1232A-R) is typically responsible for participating in controlling how data (e.g., packets) is to be routed (e.g., the next hop for the data and the outgoing physical NI for that data) and storing that routing information in the forwarding table(s) 1234A-R, and the ND forwarding plane 1226 is responsible for receiving that data on the physical NIs 1216 and forwarding that data out the appropriate ones of the physical NIs 1216 based on the forwarding table(s) 1234A-R.

FIG. 12B illustrates an exemplary way to implement the special-purpose network device 1202 according to some embodiments of the invention. FIG. 12B shows a special-purpose network device including cards 1238 (typically hot pluggable). While in some embodiments the cards 1238 are of two types (one or more that operate as the ND forwarding plane 1226 (sometimes called line cards), and one or more that operate to implement the ND control plane 1224 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1236 (e.g., a first full mesh coupling the line cards and a second full mesh coupling all of the cards).

Returning to FIG. 12A, the general purpose network device 1204 includes hardware 1240 comprising a set of one or more processor(s) 1242 (which are often COTS processors) and network interface controller(s) 1244 (NICs; also known as network interface cards) (which include physical NIs 1246), as well as non-transitory machine readable storage media 1248 having stored therein software 1250. During operation, the processor(s) 1242 execute the software 1250 to instantiate a hypervisor 1254 (sometimes referred to as a virtual machine monitor (VMM)) and one or more virtual machines 1262A-R that are run by the hypervisor 1254, which are collectively referred to as software instance(s) 1252. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 1262A-R, and that part of the hardware 1240 that executes that virtual machine (be it hardware dedicated to that virtual machine and/or time slices of hardware temporally shared by that virtual machine with others of the virtual machine(s) 1262A-R), forms a separate virtual network element(s) 1260A-R.

The virtual network element(s) 1260A-R perform similar functionality to the virtual network element(s) 1230A-R. For instance, the hypervisor 1254 may present a virtual operating platform that appears like networking hardware 1210 to virtual machine 1262A, and the virtual machine 1262A may be used to implement functionality similar to the control communication and configuration module(s) 1232A and forwarding table(s) 1234A (this virtualization of the hardware 1240 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the virtual machine(s) 1262A-R differently. For example, while embodiments of the invention are illustrated with each virtual machine 1262A-R corresponding to one VNE 1260A-R, alternative embodiments may implement this correspondence at a finer level granularity (e.g., line card virtual machines virtualize line cards, control card virtual machine virtualize control cards, etc.); it should be understood that the techniques described herein with reference to a correspondence of virtual machines to VNEs also apply to embodiments where such a finer level of granularity is used.

In certain embodiments, the hypervisor 1254 includes a virtual switch that provides similar forwarding services as a physical Ethernet switch. Specifically, this virtual switch forwards traffic between virtual machines and the NIC(s) 1244, as well as optionally between the virtual machines 1262A-R; in addition, this virtual switch may enforce network isolation between the VNEs 1260A-R that by policy are not permitted to communicate with each other (e.g., by honoring virtual local area networks (VLANs)).

Software 1250 can include code which be executed by processors 1242, cause the processors to perform operations of one or more embodiments of the present invention as part virtual machine 1262A-R.

The third exemplary ND implementation in FIG. 12A is a hybrid network device 1206, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 1202) could provide for para-virtualization to the networking hardware present in the hybrid network device 1206.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1230A-R, VNEs 1260A-R, and those in the hybrid network device 1206) receives data on the physical NIs (e.g., 1216, 1246) and forwards that data out the appropriate ones of the physical NIs (e.g., 1216, 1246). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services (DSCP) values.

The NDs of FIG. 12A, for example, may form part of the Internet or a private network; and other electronic devices (not shown; such as end user devices including workstations, laptops, netbooks, tablets, palm tops, mobile phones, smartphones, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 12A may also host one or more such servers (e.g., in the case of the general purpose network device 1204, one or more of the virtual machines 1262A-R may operate as servers; the same would be true for the hybrid network device 1206; in the case of the special-purpose network device 1202, one or more such servers could also be run on a hypervisor executed by the compute resource(s) 1212); in which case the servers are said to be co-located with the VNEs of that ND.

A virtual network is a logical abstraction of a physical network (such as that in FIG. 12A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

What is claimed is:

1. A method in a first network device that is communicatively coupled to a plurality of other network devices in a network, the method comprising:
generating a plurality of prefix entries, wherein each prefix entry includes information for associating incoming traffic to a data structure;
generating a plurality of data structures, wherein one or more of the plurality of data structures includes a reference to a master entry; and
generating the master entry, wherein the master entry includes information for determining how to use the data structures to forward incoming traffic to one or more of the plurality of other network devices.

2. The method of claim 1, wherein
generating the plurality of data structures comprises
generating a first next hop entry that includes a master entry identifier (ME ID) that references the master entry, and
generating a second next hop entry referenced by the master entry; and wherein
generating the master entry comprises
generating the master entry that includes a next hop identifier (NH ID) and information identifying a switch event, wherein a non-occurrence of the switch event causes a first chain of one or more next hop entries to be used, the first chain comprising of at least the first next hop entry, and wherein an occurrence of the switch event causes a second chain of next hops to be used, the second chain of next hops comprising of the first next hop entry and the second next hop entry referenced by the NH ID.

3. The method of claim 2, wherein the plurality of other network devices includes a second network device, wherein the first network device is configured to serve as an active inter-chassis redundancy (ICR) device of an ICR system, and the second network device is configured to serve as a standby ICR device of the ICR system.

4. The method of claim 3, wherein the second next hop entry includes information that causes incoming traffic of the first network device to be forwarded to the second network device.

5. The method of claim 4, further comprising:
in response to detecting an occurrence of the switch event, sending an indication to the second network device, the indication causing the second network device to become the active ICR device of the ICR system and further causes the second network device to not direct its incoming traffic to the first network device.

6. The method of claim 5, further comprising:
in response to receiving an indication from the second network device indicating it is ready to forward incoming traffic to a network device other than the first network device, causing the second chain of next hops to be used thereby allowing incoming traffic of the first network device to be forwarded to the second network device.

7. The method of claim 1, wherein
generating the plurality of data structures comprises
generating a Fast Re-Route next hop (FRR NH) entry that references a first chain of next hop entries and a second chain of next hop entries, and wherein the FRR NH entry includes a master entry identifier (ME ID) referencing the master entry; and wherein
generating the master entry comprises
generating the master entry that includes information identifying a switch event, wherein a non-occurrence of the switch event causes the first chain of next hop entries to be used for forwarding incoming traffic, and wherein an occurrence of the switch event causes the second chain of next hop entries to be used for forwarding incoming traffic.

8. The method of claim 7, wherein the plurality of other network devices includes a second network device, wherein the first network device is configured to serve as an active inter-chassis redundancy (ICR) device of an ICR system, and the second network device is configured to serve as a standby ICR device of the ICR system.

9. The method of claim 8, wherein the second chain of next hop entries includes information that causes incoming traffic of the first network device to be forwarded to the second network device.

10. The method of claim 9, further comprising:
in response to detecting an occurrence of the switch event, sending an indication to the second network device, the indication causing the second network device to become the active ICR device of the ICR system, and further causes the second network device to not direct its incoming traffic to the first network device.

11. The method of claim 10, further comprising:
in response to receiving an indication from the second network device indicating it is ready to forward incoming traffic to a network device other than the first network device, causing the second chain of next hop entries to be used for forwarding incoming traffic, thereby allowing incoming traffic of the first network device to be forwarded to the second network device.

12. A first network device that is communicatively coupled to a plurality of other network devices in a network, the first network device comprising:
a set of one or more processors; and
a non-transitory machine-readable storage medium containing code, which when executed by the set of one or more processors, cause the first network device to:
generate a plurality of prefix entries, wherein each prefix entry includes information for associating incoming traffic to a data structure,
generate a plurality of data structures, wherein one or more of the plurality of data structures includes a reference to a master entry, and
generate the master entry, wherein the master entry includes information for determining how to use the data structures to forward incoming traffic to one or more of the plurality of other network devices.

13. The first network device of claim 12, wherein
generating the plurality of data structures comprises the first network device to
generate a first next hop entry that includes a master entry identifier (ME ID) that references the master entry, and
generate a second next hop entry referenced by the master entry; and wherein
generating the master entry comprises the first network device to
generate the master entry that includes a next hop identifier (NH ID) and information identifying a switch event, wherein a non-occurrence of the switch event causes a first chain of one or more next hop entries to be used, the first chain comprising of at least the first next hop entry, and wherein an occurrence of the switch event causes a second chain of next hops to be used, the second chain of next hops comprising of the first next hop entry and the second next hop entry referenced by the NH ID.

14. The first network device of claim 13, wherein the plurality of other network devices includes a second network device, wherein the first network device is configured to serve as an active inter-chassis redundancy (ICR) device of an ICR system, and the second network device is configured to serve as a standby ICR device of the ICR system.

15. The first network device of claim 14, wherein the second next hop entry includes information that causes incoming traffic of the first network device to be forwarded to the second network device.

16. The first network device of claim 15, wherein the non-transitory machine-readable storage medium further contains code, which when executed by the set of one or more processors, cause the first network device to:
in response to detecting an occurrence of the switch event, send an indication to the second network device, the indication causing the second network device to become the active ICR device of the ICR system and further causes the second network device to not direct its incoming traffic to the first network device.

17. The first network device of claim 16, wherein the non-transitory machine-readable storage medium further contains code, which when executed by the set of one or more processors, cause the first network device to:
in response to receiving an indication from the second network device indicating it is ready to forward incoming traffic to a network device other than the first network device, cause the second chain of next hops to be used thereby allowing incoming traffic of the first network device to be forwarded to the second network device.

18. The first network device of claim 12, wherein
generating the plurality of data structures comprises the first network device to
generate a Fast Re-Route next hop (FRR NH) entry that references a first chain of next hop entries and a second chain of next hop entries, and wherein the FRR NH entry includes a master entry identifier (ME ID) referencing the master entry; and wherein
generating the master entry comprises the first network device to
generate the master entry that includes information identifying a switch event, wherein a non-occurrence of the switch event causes the first chain of next hop entries to be used for forwarding incoming traffic, and wherein an occurrence of the switch event causes the second chain of next hop entries to be used for forwarding incoming traffic.

19. The first network device of claim 18, wherein the plurality of other network devices includes a second network device, wherein the first network device is configured to serve as an active inter-chassis redundancy (ICR) device of an ICR system, and the second network device is configured to serve as a standby ICR device of the ICR system.

20. The first network device of claim 19, wherein the second chain of next hop entries includes information that causes incoming traffic of the first network device to be forwarded to the second network device.

21. The first network device of claim 20, wherein the non-transitory machine-readable storage medium further contains code, which when executed by the set of one or more processors, cause the first network device to:
in response to detecting an occurrence of the switch event, send an indication to the second network device, the indication causing the second network device to become the active ICR device of the ICR system, and further causes the second network device to not direct its incoming traffic to the first network device.

22. The first network device of claim 21, wherein the non-transitory machine-readable storage medium further contains code, which when executed by the set of one or more processors, cause the first network device to:
in response to receiving an indication from the second network device indicating it is ready to forward incoming traffic to a network device other than the first network device, cause the second chain of next hop entries to be used for forwarding incoming traffic, thereby allowing incoming traffic of the first network device to be forwarded to the second network device.

23. A non-transitory computer-readable storage medium having computer code stored therein, which when executed by a processor of a first network device that is communicatively coupled to a plurality of other network devices in a network, cause the first network device to perform operations comprising:
generating a plurality of prefix entries, wherein each prefix entry includes information for associating incoming traffic to a data structure;
generating a plurality of data structures, wherein one or more of the plurality of data structures includes a reference to a master entry; and
generating the master entry, wherein the master entry includes information for determining how to use the data structures to forward incoming traffic to one or more of the plurality of other network devices.

24. The non-transitory computer-readable storage medium of claim 23, wherein
generating the plurality of data structures comprises
generating a first next hop entry that includes a master entry identifier (ME ID) that references the master entry, and
generating a second next hop entry referenced by the master entry; and wherein
generating the master entry comprises
generating the master entry that includes a next hop identifier (NH ID) and information identifying a switch event, wherein a non-occurrence of the switch event causes a first chain of one or more next hop entries to be used, the first chain comprising of at least the first next hop entry, and wherein an occurrence of the switch event causes a second chain of next hops to be used, the second chain of next hops comprising of the first next hop entry and the second next hop entry referenced by the NH ID.

25. The non-transitory computer-readable storage medium of claim 24, wherein the plurality of other network devices includes a second network device, wherein the first network device is configured to serve as an active inter-chassis redundancy (ICR) device of an ICR system, and the second network device is configured to serve as a standby ICR device of the ICR system.

26. The non-transitory computer-readable storage medium of claim 25, wherein the second next hop entry includes information that causes incoming traffic of the first network device to be forwarded to the second network device.

27. The non-transitory computer-readable storage medium of claim 26, further comprising:
in response to detecting an occurrence of the switch event, sending an indication to the second network device, the indication causing the second network device to become the active ICR device of the ICR system and further causes the second network device to not direct its incoming traffic to the first network device.

28. The non-transitory computer-readable storage medium of claim 27, further comprising:
in response to receiving an indication from the second network device indicating it is ready to forward incoming traffic to a network device other than the first network device, causing the second chain of next hops to be used thereby allowing incoming traffic of the first network device to be forwarded to the second network device.

29. The non-transitory computer-readable storage medium of claim 23, wherein
generating the plurality of data structures comprises
generating a Fast Re-Route next hop (FRR NH) entry that references a first chain of next hop entries and a second chain of next hop entries, and wherein the FRR NH entry includes a master entry identifier (ME ID) referencing the master entry; and wherein
generating the master entry comprises
generating the master entry that includes information identifying a switch event, wherein a non-occurrence of the switch event causes the first chain of next hop entries to be used for forwarding incoming traffic, and wherein an occurrence of the switch event causes the second chain of next hop entries to be used for forwarding incoming traffic.

30. The non-transitory computer-readable storage medium of claim 29, wherein the plurality of other network devices includes a second network device, wherein the first network device is configured to serve as an active inter-chassis redundancy (ICR) device of an ICR system, and the second network device is configured to serve as a standby ICR device of the ICR system.

31. The non-transitory computer-readable storage medium of claim 30, wherein the second chain of next hop entries includes information that causes incoming traffic of the first network device to be forwarded to the second network device.

32. The non-transitory computer-readable storage medium of claim 31, further comprising:
in response to detecting an occurrence of the switch event, sending an indication to the second network device, the indication causing the second network device to become the active ICR device of the ICR system, and further causes the second network device to not direct its incoming traffic to the first network device.

33. The non-transitory computer-readable storage medium of claim 32, further comprising:
in response to receiving an indication from the second network device indicating it is ready to forward incoming traffic to a network device other than the first network device, causing the second chain of next hop entries to be used for forwarding incoming traffic, thereby allowing incoming traffic of the first network device to be forwarded to the second network device.
